(19) United States
(12) Patent Application Publication
(10) Pub. No.: US 2013/0293793 A1
(43) Pub. Date: Nov. 7, 2013

(54) DISPLAY APPARATUS AND CONTROL METHOD THEREOF

(71) Applicant: Chun-Fu LU, Hsinchu City (TW)

(72) Inventor: Chun-Fu LU, Hsinchu City (TW)

(73) Assignee: INDUSTRIAL TECHNOLOGY RESEARCH INSTITUTE, Hsinchu (TW)

(21) Appl. No.: 13/569,185

(22) Filed: Aug. 8, 2012

(30) Foreign Application Priority Data
May 3, 2012 (TW) 101115785

(51) Int. Cl. G02F 1/13357

(52) U.S. Cl. 349/15; 349/61

(57) ABSTRACT

A display apparatus having a backlight module, a modulatable parallax barrier module, a polarizer film and a display panel is provided. The backlight module provides a linear polarized light having a first polarization direction. The modulatable parallax barrier module has an alignment state and a transparent state, and has a first alignment film with a first alignment direction on the light-emitting side. The linear polarized light passing through the modulatable parallax barrier module in the transparent state is kept in the first polarization direction, and passing through the modulatable parallax barrier module in the alignment state is transformed to a second polarization direction. The polarizer film has a transmission axis inclined toward either the first polarization direction or the second polarization direction. The modulatable parallax barrier module selects one of the alignment state and the transparent state according to an image information provided by the display panel.

### CROSS-REFERENCE TO RELATED APPLICATION

This application claims the priority benefit of Taiwan application serial no. 101115785, filed on May 3, 2012. The entirety of the above-mentioned patent application is hereby incorporated by reference herein and made a part of this specification.

### BACKGROUND

1. Technical Field

The disclosure is directed to a display apparatus and a control method thereof, and more particularly to a display apparatus capable of being switched to a planar image or a three-dimensional (3D) image and a control method thereof.

2. Related Art

In recent years, continuous advancement of display technologies results in increasing demands on display quality of displays, such as image resolution, color saturation, and so on. Nevertheless, besides high image resolution and high color saturation, a display apparatus capable of displaying a three-dimensional (3D) image is developed so as to meet a viewer demand on watching real and lively images.

FIG. 1A is a schematic view of a display apparatus capable of displaying a 3D image in the related art. As shown in FIG. 1A, a display apparatus 100 includes a backlight module 110, a display panel 120 having pixels, and a parallax barrier 130 disposed between the backlight module 110 and the display panel 120. FIG. 1B is a schematic view of the display apparatus depicted in FIG. 1A simultaneously presenting a planar image and a 3D image. As shown in FIG. 1B, a predefined display region 100A for the planar image in the display apparatus 100 is, for example, disposed at two sides of a predefined display region 100B for the 3D image. A portion of the parallax barrier in the predefined display region 100B for the 3D image shields the light, such that the light passing therethrough to a viewer's left and right eyes respectively presents the left eye image and the right eye image, as shown in FIG. 1A. As a result, however, the quantity of the light passing through the predefined display region 100A for the planar image is larger than the quantity of the light passing through the predefined display region 100B for the 3D image, such that when viewing the planar image and the 3D image presented in the display apparatus, the viewer will experience obvious difference of the brightness. Even though the planar image and the 3D image respectively presented in different timings in the display apparatus, the viewer will also easily experiences the obvious brightness difference between of display apparatus being when being switched to the planar image mode and to the 3D image mode. Accordingly, how to keep the brightness in consistency when the display apparatus is switched to the 3D image mode and to the planar image mode is a major concern in the industry.

### SUMMARY

A display apparatus is introduced herein, which is capable of switching a modulatable parallax barrier module according to an image information provided by a display panel so as to balance a brightness difference of the display apparatus between the brightness for presenting a planar image and the brightness for presenting a three-dimensional (3D) image.

A control method of a display apparatus is introduced herein, by which a modulatable parallax barrier module is switched, and a brightness of a backlight module is partially modulated according to an image information provided by a display panel so as to balance the brightness of the display apparatus when presenting a planar image and when presenting a 3D image.

A display apparatus including a backlight module, a modulatable parallax barrier module, a polarizer film and a display panel is introduced herein. The backlight module is adapted to providing a linear polarized light having a first polarization direction. The modulatable parallax barrier module is disposed on the backlight module and has an alignment state and a transparent state. The modulatable parallax barrier module has a first alignment film at a light-emitting side and a second alignment film having a second alignment direction at a light-incident side, in which the first alignment film has a first alignment direction. The linear polarized light passing through the modulatable parallax barrier module in the transparent state is kept in the first polarization direction, and the linear polarized light passing through the modulatable parallax barrier module in the alignment state is transformed to a second polarization direction parallel to the first alignment direction. The polarizer film is disposed on the first alignment film and has a transmission axis. The transmission axis is inclined toward either the first polarization direction or the second polarization direction. The display panel is configured to provide an image information, and the modulatable parallax barrier module is selectively switched to either the alignment state or the transparent state according to the image information.

Another display apparatus is further introduced herein, which includes a backlight module, a display panel, a modulatable parallax barrier module and a polarizer film. The backlight module with the display panel is adapted to providing a linear polarized light having an image information. The linear polarized light has a first polarization direction. The modulatable parallax barrier module is disposed on the display panel and has an alignment state and a transparent state. The modulatable parallax barrier module has a first alignment film at a light-incident side of the modulatable parallax barrier module, and the first alignment film has a first alignment direction. The linear polarized light passing through the modulatable parallax barrier module in the transparent state is kept in the first polarization direction. The linear polarized light passing through the modulatable parallax barrier module in the alignment state is transformed to a second polarization direction parallel to the first polarization direction. The polarizer film is disposed on the first alignment film and has a transmission axis. Either the first alignment direction of the first alignment film or a second alignment direction of the second alignment film is inclined toward the transmission axis, and the modulatable parallax barrier module is selectively switched to either the alignment state or the transparent state according to the image information.

Another control method of the display apparatus is further introduced herein, which includes steps as follows. Whether an image information is a text, a planar image or a 3D image is determined. When the image information is a text or a planar image, the modulatable parallax barrier module is entirely switched to the alignment state or the transparent state (referring to FIGS. 4B and 5A). When the image information is a 3D image, the modulatable parallax barrier module is entirely switched to the transparent state or the alignment state. When both the planar image and the 3D image are included in the image information, a part of the modulatable parallax barrier module is switched to the alignment state, and the other part of the modulatable parallax barrier module is switched to the transparent state.

Still another control method of the display apparatus is further introduced herein, which includes steps as follows. Whether an image information is a text, a planar image or a 3D image is determined. When the image information is a text or a planar image, the modulatable parallax barrier module is entirely switched to the alignment state. When the image information is a 3D image, a part of the modulatable parallax barrier module where stripe electrodes are disposed is switched to the transparent state.

To sum up, by the display apparatus and the control method thereof introduced herein, the modulatable parallax barrier module can be controlled according to the image information to be displayed by the display panel so that the modulatable parallax barrier module is switched to either the alignment state or the transparent state correspondingly. Besides, the alignment direction of either the first alignment film or the second alignment film is inclined toward the transmission axis of the polarizer film, and thus, the brightness presenting the planar image and the brightness presenting the 3D image intend to consistency. Even though the planar image and the 3D image are simultaneously presented in the display apparatus, the planar and the 3D images with more consistent brightness can be provided.

In order to make the aforementioned features and advantages of the disclosure more comprehensible, embodiments accompanying figures are described in detail below

### BRIEF DESCRIPTION OF THE DRAWINGS

The accompanying drawings are included to provide further understanding, and are incorporated in and constitute a part of this specification. The drawings illustrate embodiments and, together with the description, serve to explain the principles of the disclosure.

FIG. 1A is a schematic view of a display apparatus capable of displaying a three-dimensional (3D) image in the related art.

FIG. 1B is a schematic view of the display apparatus depicted in FIG. 1A simultaneously presenting a planar image and a 3D image.

FIG. 2A through 2C are schematic views respectively illustrating an application according to an embodiment of the disclosure.

FIG. 3A is a schematic view of a display apparatus simultaneously presenting a planar image and a 3D image according to a first embodiment of the disclosure.

FIG. 3B is a schematic view illustrating another display apparatus of the disclosure.

FIG. 4A is a schematic view illustrating a display status of the display apparatus depicted in FIG. 3A entirely switched to a 3D image mode.

FIG. 4B is a schematic view illustrating a display status of the display apparatus depicted in FIG. 3A entirely switched to a planar image mode.

FIG. 5A is a schematic view illustrating a display status of the display apparatus depicted in FIG. 3A entirely switched to a planar image mode.

FIG. 5B is a schematic view illustrating another display status of the display apparatus depicted in FIG. 3A entirely switched to a 3D image mode.

FIG. 6A is a schematic view illustrating a display apparatus according to the first embodiment of the disclosure.

FIG. 6B is a schematic view illustrating another display apparatus according to the first embodiment of the disclosure.

FIG. 7A through 7E and FIG. 7F through 7J are schematic views illustrating scenarios where an included angle between a first polarization direction (0 degree, 45 degrees, 90 degrees and 135 degrees) and a transmission axis of a patterned micro-retarder is 0 degree and other certain degrees.

FIG. 8 is a schematic view of a display apparatus simultaneously presenting a planar image and a 3D image according to a second embodiment of the disclosure.

FIG. 9 is a schematic view of a display apparatus simultaneously presenting a planar image and a 3D image according to a third embodiment of the disclosure.

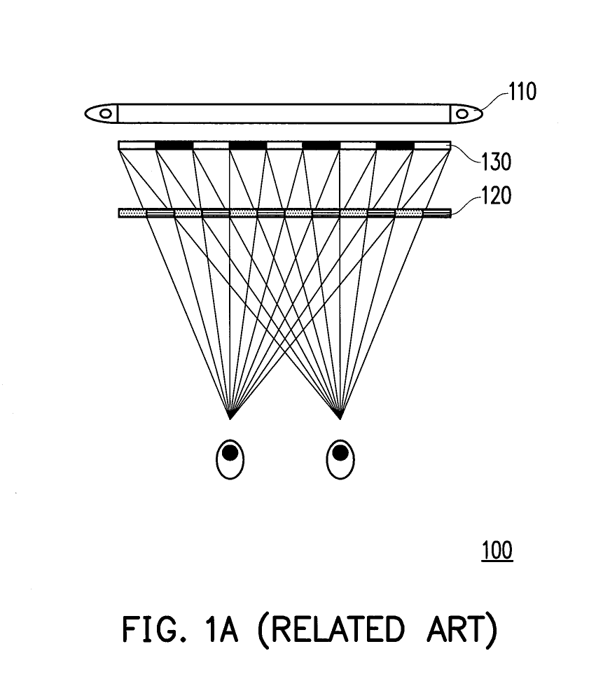

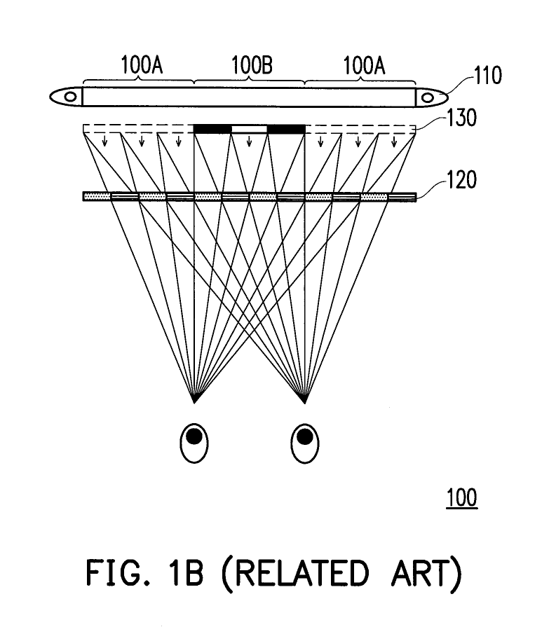

### DETAILED DESCRIPTION OF DISCLOSED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In an embodiment of the disclosure, a display apparatus is provided. The display apparatus has a modulatable parallax barrier module capable of being entirely or partially switched to either an alignment state or a transparent state according to an image information. A first alignment film disposed at a light-emitting side of the modulatable parallax barrier module has a first alignment direction inclined toward a transmission axis of a polarizer film so that a linear polarized light passing through the modulatable parallax barrier module switched to the transparent state is in a first polarization direction having a component parallel to the transmission axis of the polarizer film to pass through a polarizer. Accordingly, a brightness of the linear polarized light passing through a predefined display region for a planar image can be adequately reduced, and thereby, the display apparatus can be provided with a more consistent brightness even though presenting the planar image and a three-dimensional (3D) image simultaneously.

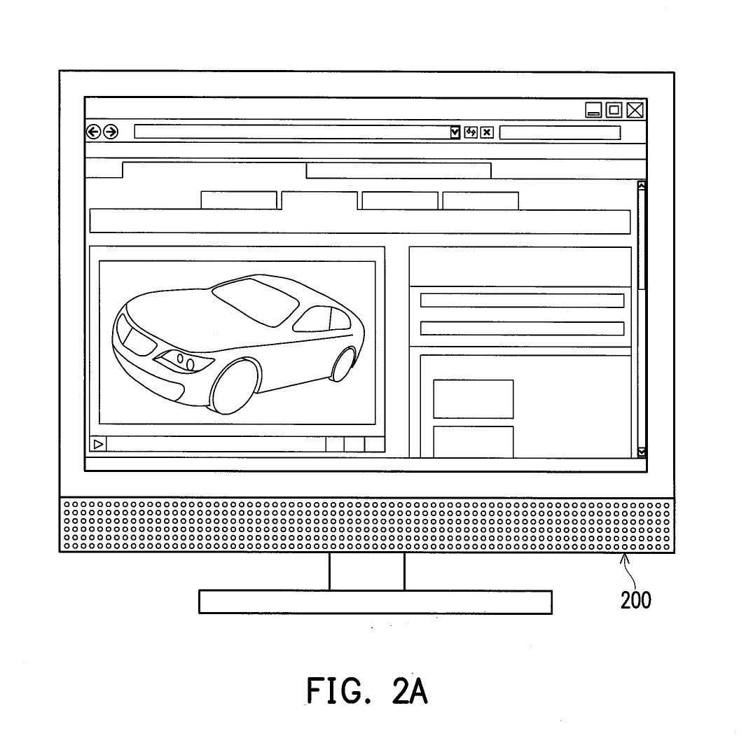

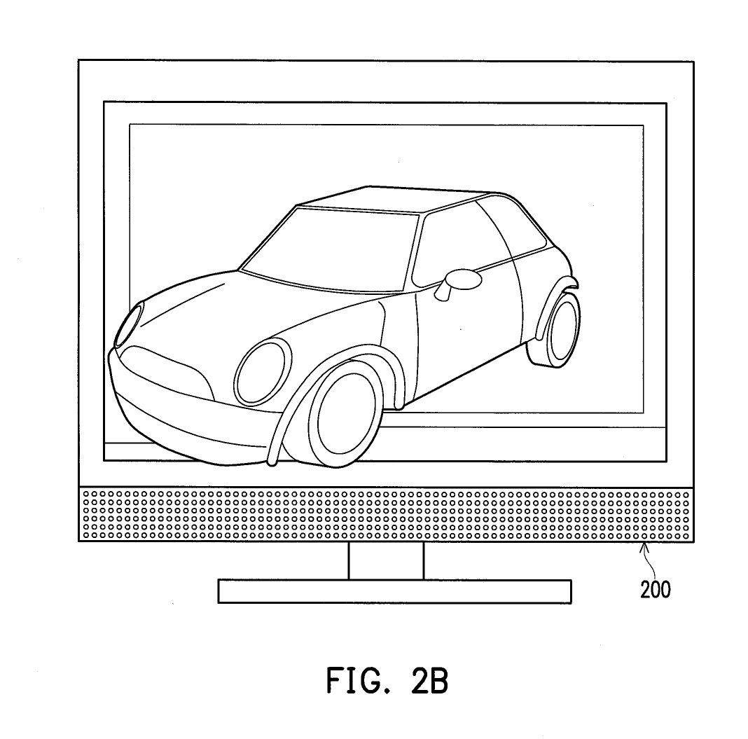

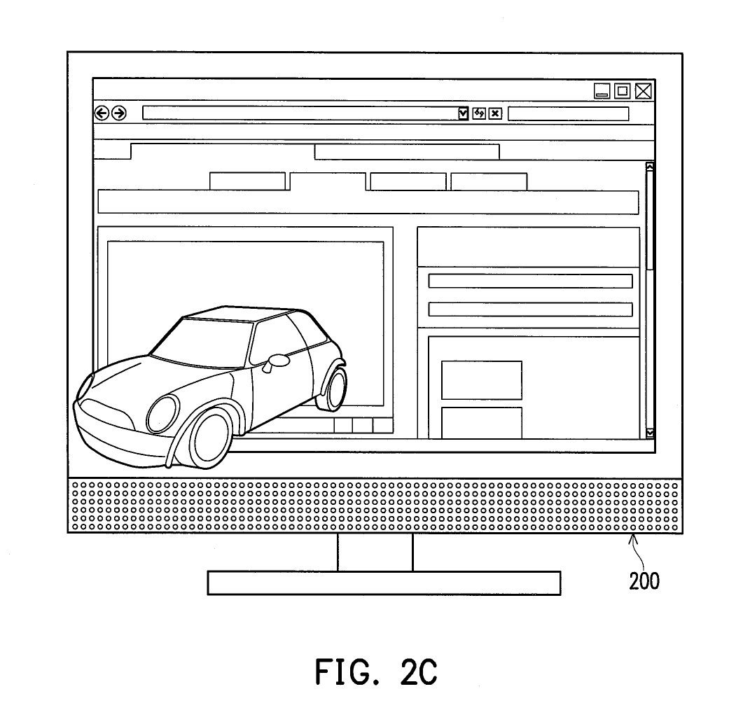

FIG. 2A through 2C are schematic views respectively illustrating an application according to an embodiment of the disclosure. Herein, FIG. 2A is a schematic view illustrating a display apparatus 200 entirely displaying a planar image, FIG. 2B is a schematic view illustrating the display apparatus 200 entirely displaying a 3D image, and FIG. 2C is a schematic view illustrating the display apparatus 200 partially displaying the 3D image in a background of displaying the planar image. As shown in FIGS. 2A through 2C, the display apparatus of the disclosure can keep the brightness in consistency when displaying the planar image, the 3D image or the both simultaneously so as to provide a viewer with better display quality.

Some implementation scenarios of the display apparatus of the disclosure will be illustrated hereinafter; however, the disclosure is not limited thereto.

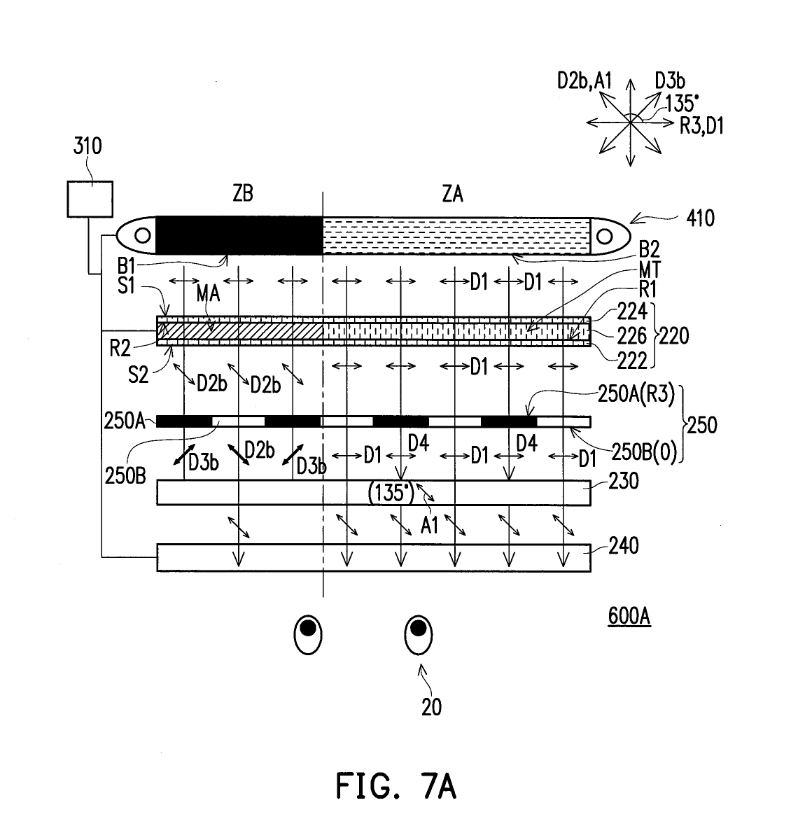

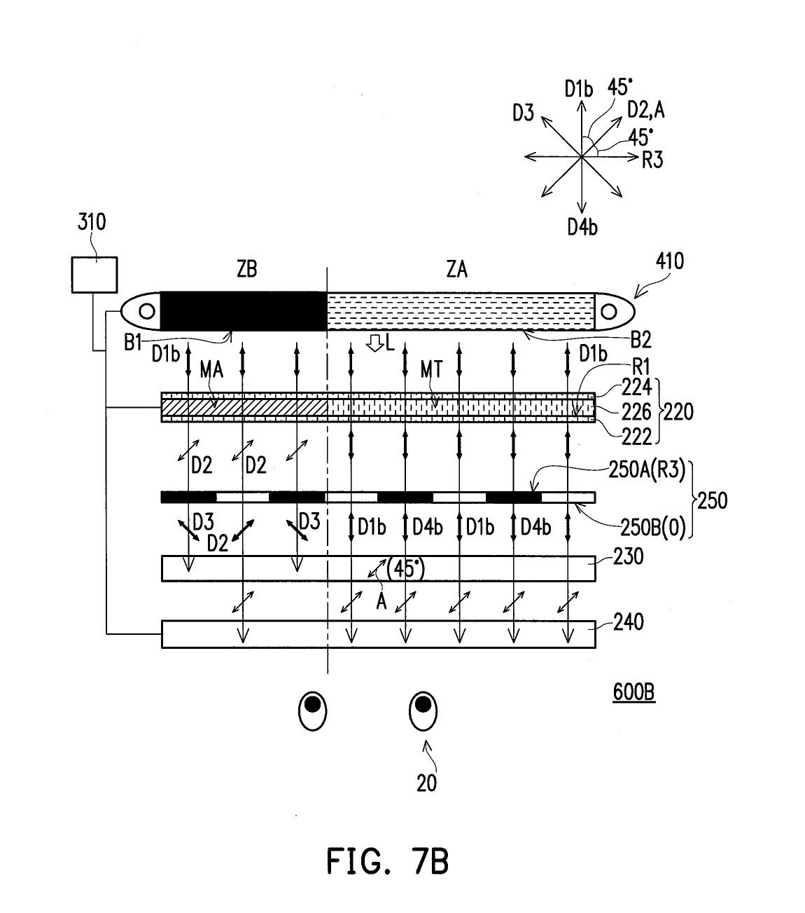

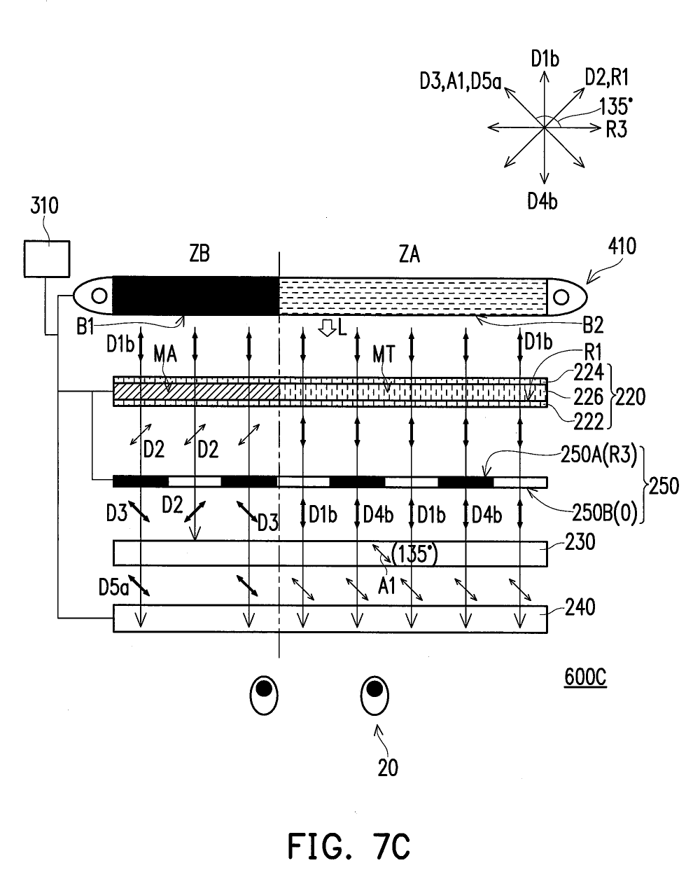

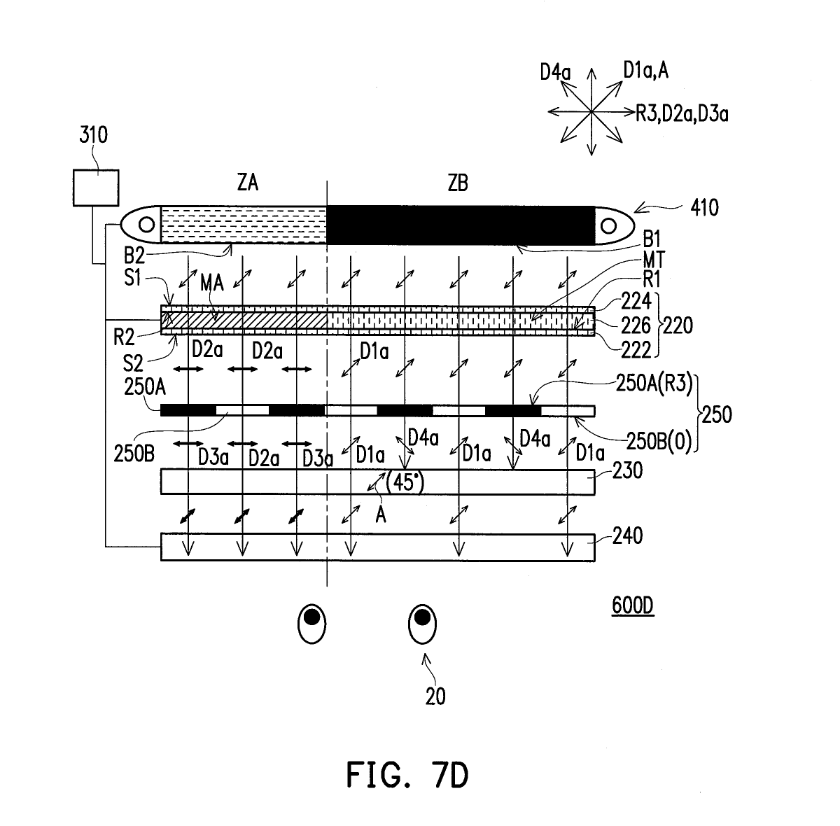

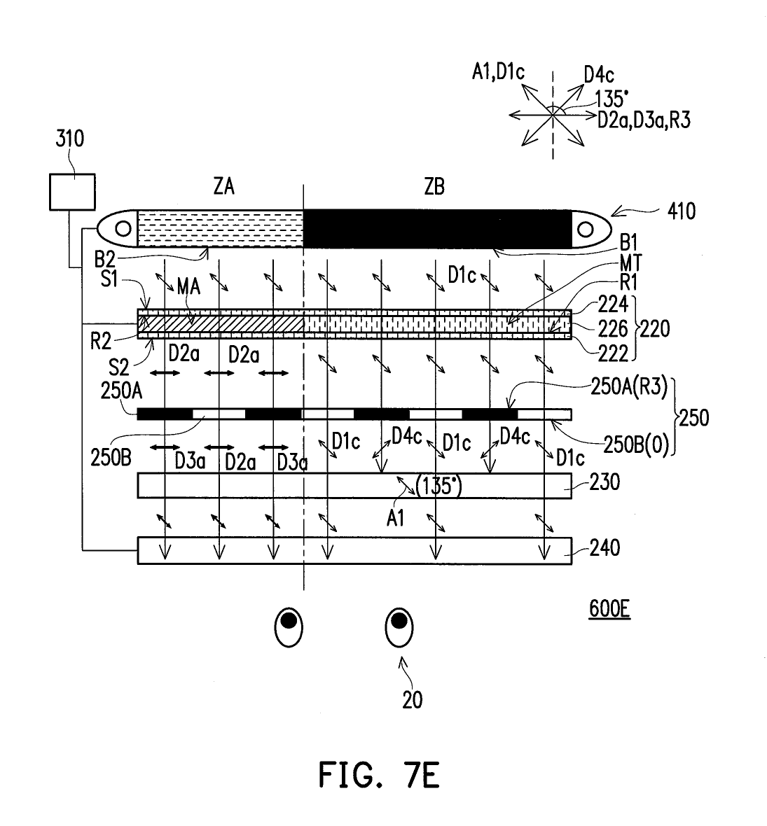

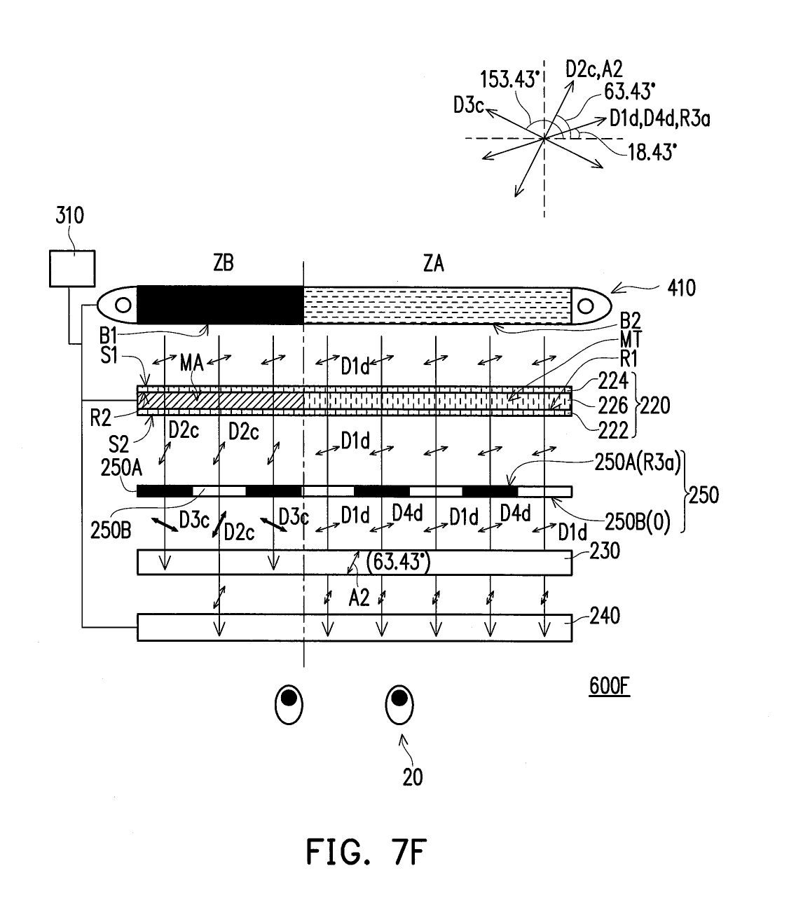

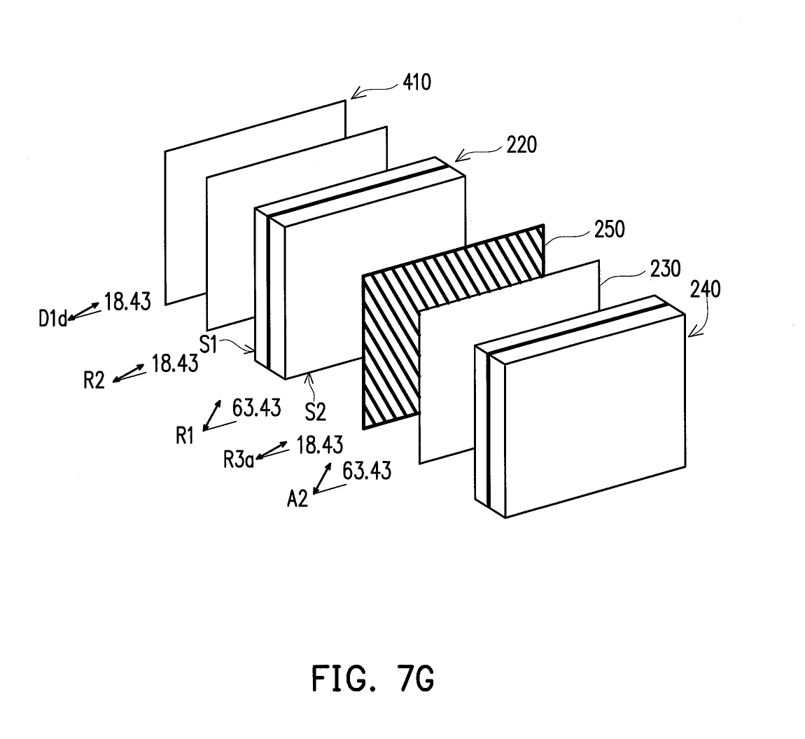

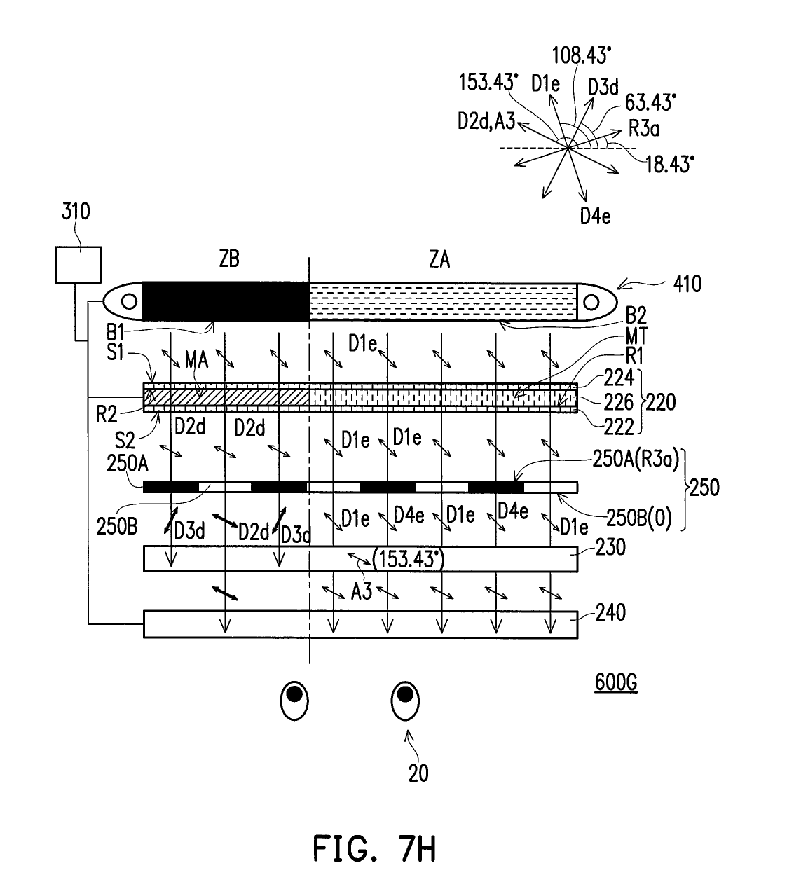

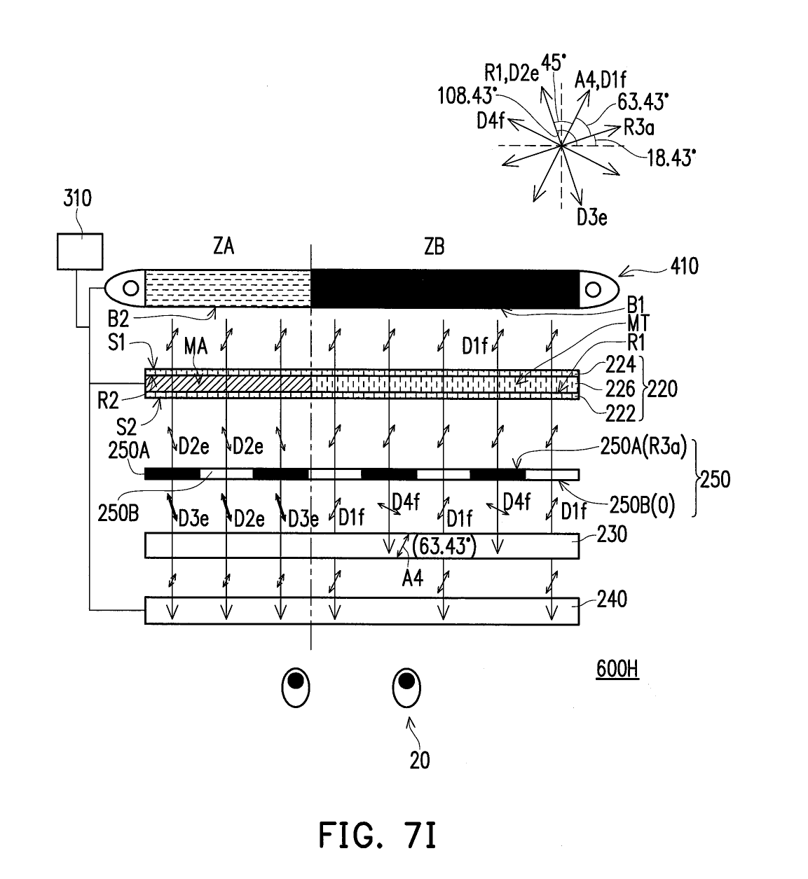

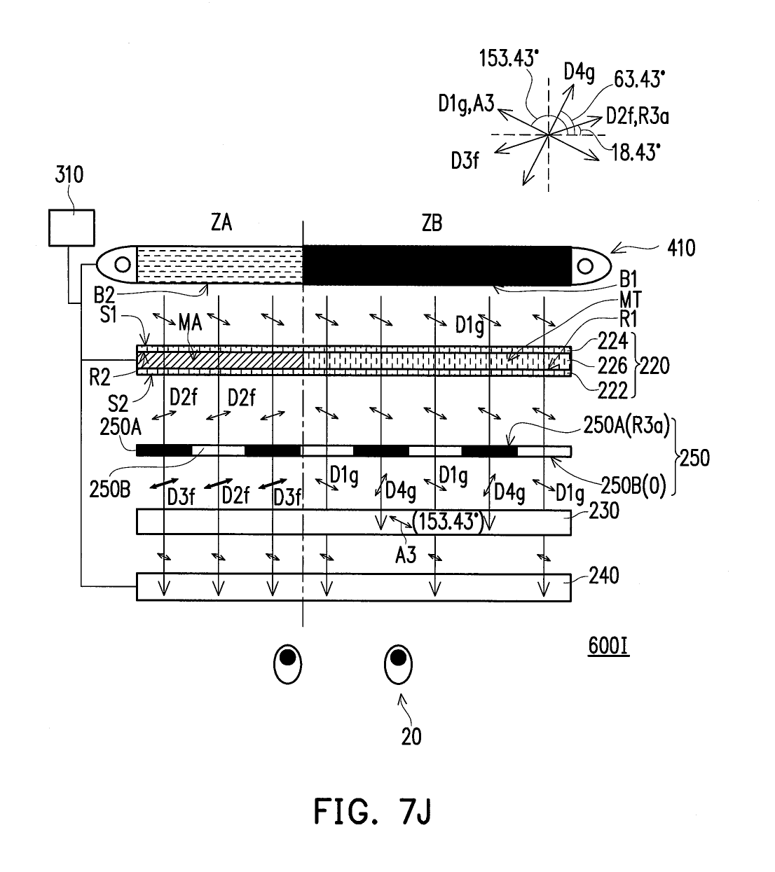

Meanwhile, the description hereinafter of changes of the polarization direction of the linear polarized light passing through each element of the display apparatus is made based on a plane visible to the viewer when viewing the display apparatus and with reference to the following drawings. Namely, a visual direction of the user is along a thickness direction of each element of the display apparatus. Besides, the angle of the linear polarized light as referred to indicate the included angle between the linear polarized light and a side (e.g. the long side as shown in FIG. 7G) of the display apparatus on the plane viewed by the user.

### First Embodiment

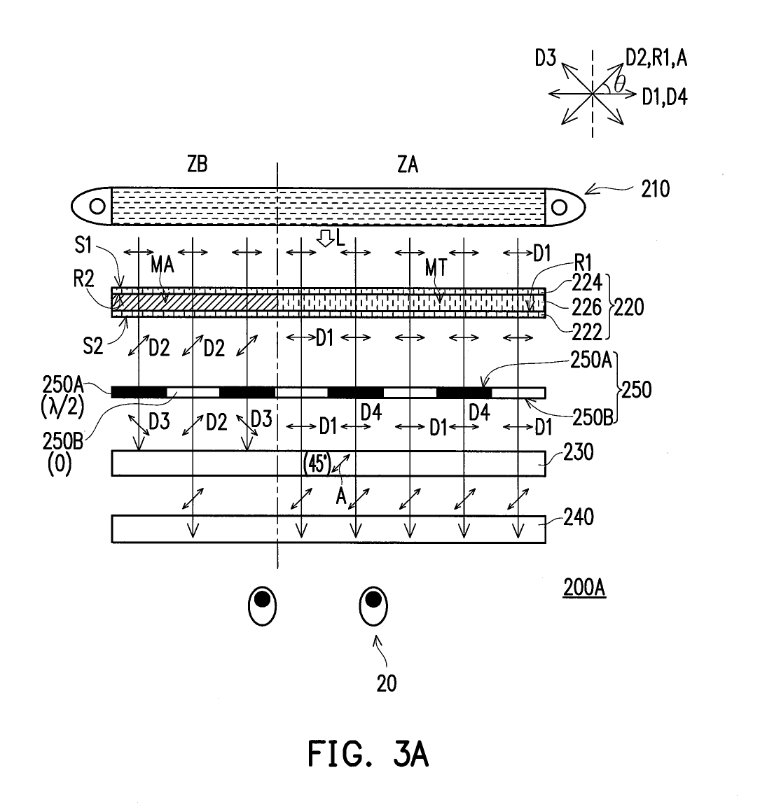

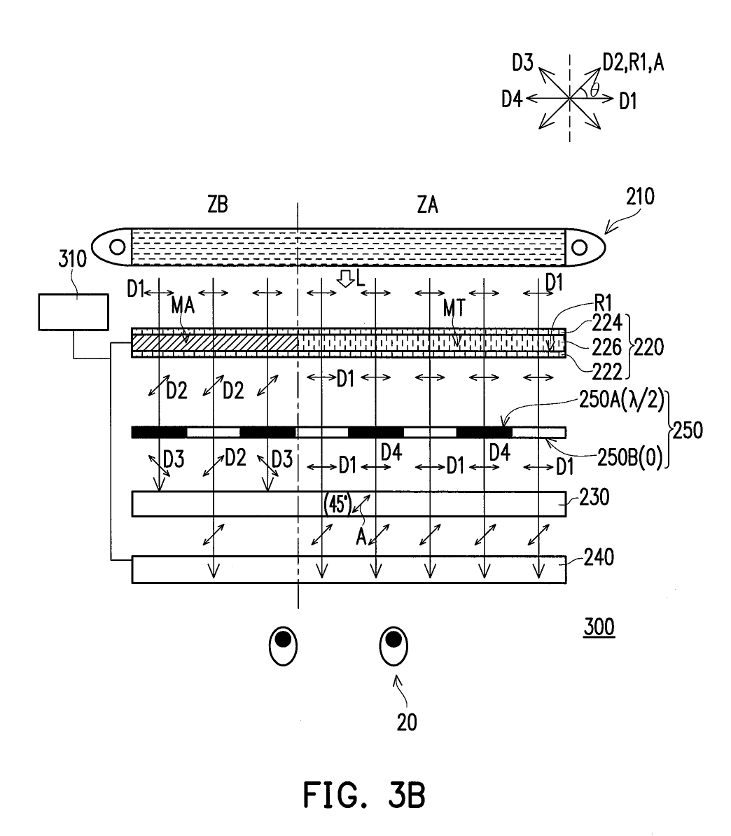

FIG. 3A is a schematic view of a display apparatus simultaneously presenting a planar image and a 3D image according to a first embodiment of the disclosure, in which the display apparatus 200A has a planar-image predefined display region ZA and a 3D-image predefined display region ZB.

As illustrated in FIG. 3A, the display apparatus 200A is adapted to being viewed by a viewer 20. The display apparatus 200A includes a backlight module 210, a modulatable parallax barrier module 220, a polarization film 230 and a display panel 240. The backlight module 210 is adapted to providing a linear polarized light L having a first polarization direction D1. As described above, the first polarization direction D1 as depicted is actually a direction oscillating on the displaying plane when the viewer 20 views the display apparatus 200A, and the polarization direction is parallel to the long side (the horizontal side) of the display apparatus 200A. The modulatable parallax barrier module 220 is disposed on the backlight module 210. In the present embodiment, the modulatable parallax barrier module 220 has a second alignment film 224 at a light-incident side S1 and has a first alignment film at a light-emitting side S2, respectively. The second alignment film 224 and the first alignment film 222 respectively have a second alignment direction R2 and a first alignment direction R1. The polarizer film 230 is disposed on the first alignment film 222 and the polarizer film 230 has a transmission axis A. Specially, in the present embodiment, the second alignment direction R2 of the second alignment film 224 is inclined toward the transmission axis A of the polarizer film 230. Otherwise, in other embodiments, it may also be the first alignment direction R1 of the first alignment film 222 inclined toward the transmission axis A of the polarizer film 230. Besides, the modulatable parallax barrier module 220 has an alignment state MA and a transparent state MT. The modulatable parallax barrier module 220 is selectively switched to either the alignment state MA or the transparent state MT according to an image information provided by the display panel 240. Thus, the brightness of the display apparatus 200A when displaying the planar image is more consistent with that when displaying the 3D image. In other words, FIG. 3A is a schematic view illustrating that a part of the modulatable parallax barrier module 220 is switched to the alignment state MA, and the other part of the modulatable parallax barrier module 220 is switched to the transparent state MT.

In detail, the linear polarized light L passing through the modulatable parallax barrier module 220 in the transparent state MT is kept in the first polarization direction, and the linear polarized light L passing through the modulatable parallax barrier module 220 in the alignment state MA is transformed to a second polarization D2 direction parallel to the first alignment direction R1. In other words, in the display apparatus of the disclosure, as long as the transmission axis is inclined toward either one of the first polarization direction and the second polarization direction, the disclosure can be achieved. In the display apparatus 200A of the present embodiment, a patterned micro-retarder 250 may be further disposed between the modulatable parallax barrier module 220 and the polarizer film 230 to serve as a parallax barrier for presenting the 3D image. Certainly, in other embodiments, the patterned micro-retarder 250 may not be additionally disposed. In stead, by only disposing a plurality of stripe electrodes separated from each other in the modulatable parallax barrier module 220, the alignment state MA and the transparent state MT may be formed alternatively with each other on a corresponding liquid crystal layer so that the plurality of stripe electrodes serve as the parallax barrier for presenting the 3D image. The implementation scenario where the parallax barrier is formed by disposing the stripe electrodes will be described later in a second embodiment.

Continuously referring to FIG. 3A, the patterned micro-retarder 250 of the display apparatus 200A of the present embodiment has a plurality of phase retardation patterns 250A and a plurality of zero retardation patterns 250B. The plurality of phase retardation patterns and the plurality of zero retardation patterns are aligned alternatively with each other, and a retardation of each phase retardation pattern is λ/2. Meanwhile, in the present embodiment, the modulatable parallax barrier module 220 includes a second alignment film 224 disposed at the light-incident side S1 thereof and a liquid crystal layer 226 disposed between the first alignment film 222 and the second alignment film 224. A material of the liquid crystal layer 226 is, for example, twisted nematic liquid crystal (TN-LC) or super twisted nematic liquid crystal (STN-LC).

As shown in the 3D-image predefined display region ZB in FIG. 3A, the modulatable parallax barrier module 220 is switched to the alignment state MA. The alignment state as referred to herein indicates that liquid crystal molecules at two sides of the liquid crystal layer 226 is aligned respectively based on the first alignment direction R1 and the second alignment direction R2 so that the first polarization direction D1 of the linear polarized light L is twisted as the polarization direction D2 parallel to the first alignment direction R1. Afterward, the linear polarized light L emitted from the modulatable parallax barrier module 220 has the second polarization direction D2. Then, after a portion of the linear polarized light L passes through the phase retardation patterns 250A, an included angle between an extension direction of the phase retardation patterns 250A and the second polarization direction D2 is 45 degrees. Thus, the second polarization direction D2 of an incident light is transformed to a third polarization direction D3 perpendicular to the second polarization direction D2 to emit from the patterned micro-retarder 250. As described above, the second polarization direction D2 as depicted is actually a direction oscillating on the displaying plane when the viewer 20 views the display apparatus 200A, and the included angle between the polarization direction and the long side (the horizontal side) of the display apparatus 200A is substantially 45 degrees. On the other hand, the other portion of the linear polarized light L passing through the zero retardation patterns 250B is kept in the second polarization direction and emits from the patterned micro-retarder 250. Thus, after sequentially passing through the alignment state MA of the modulatable parallax barrier module 220 and the patterned micro-retarder 250, the polarization direction of the linear polarized light L provided by the backlight module 210 is transformed along the horizontal direction of the patterned micro-retarder 250 to the third polarization direction D3 and the second polarization direction D2 alternative with each other. For example, from the left side in FIG. 3A, the linear polarized light L has the third polarization direction D3 in odd rows and the second polarization direction D2 in even rows. As described above, the third polarization direction D3 as depicted is actually a direction oscillating on the displaying plane when the viewer 20 views the display apparatus 200A. As shown in the top-right of FIG. 3A, in the displaying plane which is a plane visible to the viewer, the polarization direction substantially has an included angle of 135 degrees with the long side (the horizontal side) of the display apparatus 200A and is perpendicular to the second polarization D2. Afterward, in the present embodiment, since the third polarization direction D3 is perpendicular to the transmission axis A of the polarizer film 230, the linear polarized light L having the third polarization direction D3 can not pass through the polarizer film 230, such that a light-shielding region is formed in the patterned micro-retarder 250. On the other hand, since the third polarization direction D2 is parallel to the transmission axis A of the polarizer film 230, the linear polarized light L has the second polarization direction D2 can almost entirely pass through the polarizer film 230 such that a light-transmissive region is formed in the patterned micro-retarder 250. Therefore, after the linear polarized light L provided by the backlight module 210 passes through the patterned micro-retarder 250, the light-transmissive region is presented in the odd rows and the light-shielding region is presented in the even rows of the patterned micro-retarder 250, and thereby, the viewer 20 can observe the 3D image provided by the display panel 240 with both the left and the right eyes respectively.

It is to be mentioned that in the 3D-image predefined display region ZB in the present embodiment, the linear polarized light L having the third polarization direction D3 can not pass through the patterned micro-retarder 250, and thus, as for the linear polarized light L having the first polarization direction D1 emitted from the modulatable parallax barrier module 220, the quantity of the light passing through the patterned micro-retarder 250 is approximately reduced by half. In other words, since the display apparatus 200A of the present embodiment has the patterned micro-retarder 250 configured as the parallax barrier for presenting the 3D image, the light-shielding region in the parallax barrier unavoidably leads the brightness to be reduced.

Further, with reference to the planar-image predefined display region ZA at the right in FIG. 3A, the modulatable parallax barrier module 220 is switched to the transparent state MT. The transparent state MT as referred to herein indicates that the liquid crystal molecules in the liquid crystal layer 226 is driven by a voltage to be aligned perpendicularly and presented in a entirely transparent status so that the linear polarized light L passing through the modulatable parallax barrier module 220 in the transparent state MT is kept in the first polarization direction D1. Then, after a portion of the linear polarized light L passes through the phase retardation patterns 250A, the extension direction (or an optical axis direction) of the phase retardation patterns 250A has an included angle of 0 degree with the first polarization direction D1, and thus, the first polarization direction D1 passing through the phase retardation patterns is not changed and kept in a fourth polarization direction D4 parallel to the first polarization direction D1 to emit from the patterned micro-retarder 250. The fourth polarization direction D4 as illustrated is defined as the same as the aforementioned first polarization direction D1 and will not describe repeatedly hereinafter.

On the other hand, the other portion of the linear polarized light L passing through the zero retardation patterns 250B is kept in the first polarization direction D1 to emit from the patterned micro-retarder 250. Thus, the polarization direction of the linear polarized light L provided by the backlight module 210 passing through the transparent state MT of the modulatable parallax barrier module 220 and the patterned micro-retarder 250 is transformed along the horizontal direction of the patterned micro-retarder 250 to the first polarization direction D1 and the fourth polarization direction D4 alternative with each other. For example, from the planar-image predefined display region ZA at the left side in FIG. 3A, the linear polarized light L has the first polarization direction D1 in the odd rows and the fourth polarization direction D4 in the even rows. The linear polarized light L having both the first polarization direction D1 and the fourth polarization direction D4 has a component parallel to the transmission axis A so as to pass through the polarizer film 230 successfully, and the image information now is the planar image.

It is to be mentioned that the quantity of the linear polarized light L having the first polarization direction D1 and the fourth polarization direction D4 passing through the polarizer film 230 may be controlled by modulating the included angle between the first alignment direction R1 and the transmission axis A. As described above, the direction of the transmission axis A herein indicates the horizontal direction located on the polarizer film 230, and substantially has an included angle of 45 degrees with the direction and the long side (horizontal side) of the polarizer film 230. For example, when the included angle θ between the first alignment direction R1 of the first alignment film 222 and the transmission axis A is 45 degrees, the quantity of the linear polarized light L having the first polarization direction D1 passing through the polarizer film 230 is approximately reduced by half since the included angle between the first polarization direction D1 and the transmission axis A is also 45 degrees. On the other hand, in the present embodiment, the quantity of the linear polarized light L having the fourth polarization direction D4 passing through the polarizer film 230 is also approximately reduced by half since the included angle between the fourth polarization direction D4 and the transmission axis A is also 45 degrees. Accordingly, the display brightness in the planar-image predefined region ZA of the display apparatus 200A is approximately reduced by half before and after passing through the polarizer film 230, and thus, the display brightness in the 3D-image predefined display region ZB of the display apparatus 200A tends to be consistent with the display brightness in the planar-image predefined region ZA of the display apparatus 200A.

For the brightness of the display apparatus 200A reduced in the parallax barrier, the modulatable parallax barrier module 220 is disposed in the display apparatus 200A. By way of having an the included angle between the first alignment direction R1 of the first alignment film 222 in the modulatable parallax barrier module 220 and the transmission axis A of the polarizer film 230 that is not perpendicular, the linear polarized light L passing through the transparent state MT of the modulatable parallax barrier module 220 only has the light component parallel to the transmission axis A, which is capable of passing through the polarizer film 230. As such, the brightness in the planar-image predefined display region ZA is reduced according to a level which the brightness in the 3D-image predefined display region ZB of the display apparatus 200A is reduced by the parallax barrier. Thereby, the display brightness of the display apparatus 200A displaying the planar image tends to be consistent with the display brightness of the display apparatus 200A displaying the 3D image.

A control method of the display apparatus 200A depicted in FIG. 3A will be illustrated hereinafter, which includes steps as follows. Whether the image information is a text, a planar image or a 3D image is determined. When the image information is a text or a planar image, the modulatable parallax barrier module 220 is entirely switched to the transparent state MT. When the image information is a 3D image, the modulatable parallax barrier module 220 is entirely switched to the alignment state MA. When the image information has both a planar image and a 3D image, a part of the modulatable parallax barrier module 220 is switched to the alignment state MA, and the other part thereof is switched to the transparent state MT. FIG. 3B is a schematic view illustrating another display apparatus of the disclosure. FIG. 3B illustrates a display apparatus 300 similar to the display apparatus 200A depicted in FIG. 3A, though the display apparatus 300 depicted in FIG. 3B further includes a control unit 310, and the other elements, the light polarization directions, the definition of the transmission axis is the same as illustrated in FIG. 3A. In short, the polarization direction as depicted is actually a direction horizontally oscillating on the displaying plane when the viewer 20 views the display apparatus of the present embodiment, and the included angle of the polarization direction is corresponding to the long side (the horizontal side) of the display apparatus of the present embodiment. As illustrated in FIG. 3B, the control unit 310 is electrically connected with the modulatable parallax barrier module 220 and the display panel 240. The control unit 310 controls the modulatable parallax barrier module 220 to be partially or entirely switched to either the alignment state MA or the transparent state MT according to the image information of the display panel 240.

A control method of the display apparatus 300 depicted in FIG. 3B will be illustrated hereinafter. Comparing with the control method as illustrated in FIG. 3A, the control method of the display apparatus 300 further includes steps as follows. When the image information is a text or a planar image, the control unit 310 controls the modulatable parallax barrier module 220 to be entirely switched to the transparent state MT and controls the backlight module 210 to execute a brightness balance. When the image information is a 3D image, the control unit 310 controls the modulatable parallax barrier module 220 to be entirely switched to the alignment state MA and controls the backlight module 210 to execute a brightness compensation. When the image information has both a planar image and a 3D image, the control unit 310 controls a part of the modulatable parallax barrier module 220 to be switched to the alignment state MA, controls the other part thereof to be switched to the transparent state MT and controls the backlight module 210 to execute a brightness modulation in blocks of the backlight module 210 respectively corresponding to the alignment state MA and the transparent state MT. In addition, the control unit 310 can control the boundaries of blocks ZA, ZB of the backlight module 210 respectively corresponding to the alignment state MA and those corresponding to the transparent state MT to be presented in different brightness.

In each of the following embodiments, the definition of the light polarization directions and the transmission axis are the same as those illustrated in FIG. 3A. In short, the polarization direction as depicted is actually a direction horizontally oscillating on the displaying plane when the viewer 20 views the display apparatus of each embodiment, and the included angle is between the polarization direction and the corresponding long side (the horizontal side) of the display apparatus of each embodiment.

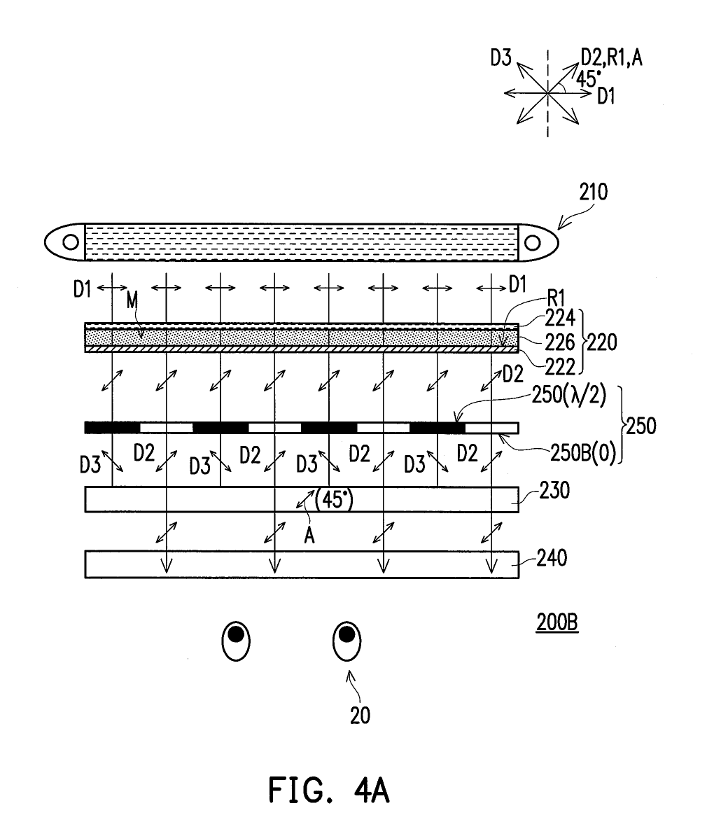

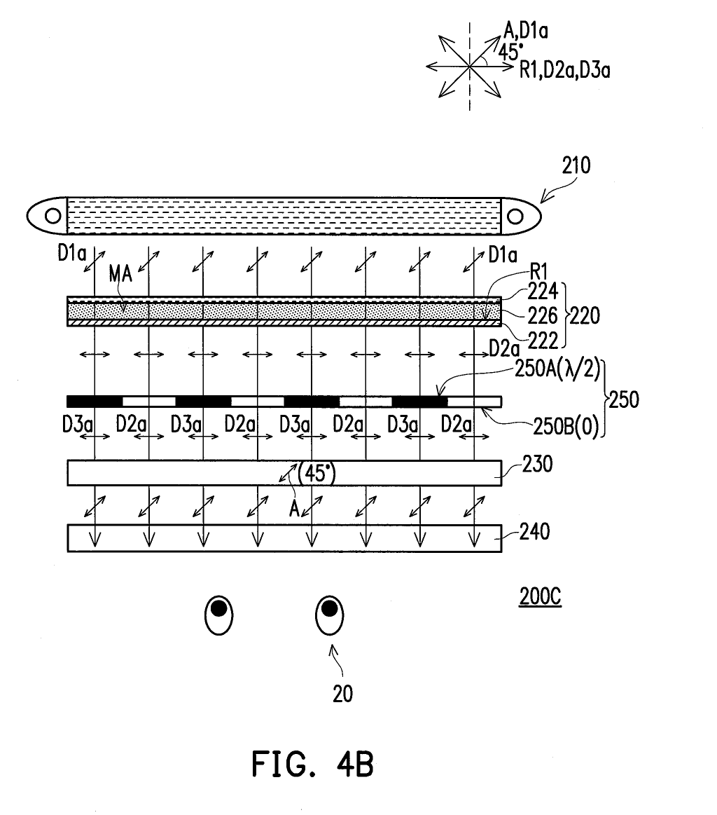

FIG. 4A is a schematic view illustrating a display status of the display apparatus depicted in FIG. 3A entirely switched to a 3D image mode. FIG. 4A illustrates a display apparatus 200B similar to the display apparatus 200A depicted in FIG. 3, though in the present embodiment, the modulatable parallax barrier module 220 is entirely switched to the alignment state MA, and by way of the liquid crystal layer 226 of the modulatable parallax barrier module 220, the first polarization direction D1 of the linear polarized light L passing through the modulatable parallax barrier module 220 is transformed to the second polarization direction D2 parallel to the first alignment direction R1 to emit.

Likewise, after a portion of the linear polarized light L having the second polarization direction D2 passes through the phase retardation patterns 250A, the second polarization direction D2 is transformed to a third polarization direction D3 perpendicular to the second polarization direction D2 to emit from the patterned micro-retarder 250. On the other hand, the other portion of the linear polarized light L passing through the zero retardation patterns 250B is kept in the second polarization direction D2 to emit from the patterned micro-retarder 250. Thus, after the linear polarized light L provided by the backlight module 210 passes through the alignment state MA of the modulatable parallax barrier module 220 and the patterned micro-retarder 250, the linear polarized light L passing through the patterned micro-retarder 250 is transformed along the horizontal direction of the patterned micro-retarder 250 to the third polarization direction D3 and the second polarization direction D2 alternative with each other. For example, from the left side in FIG. 3A, the linear polarized light L has the third polarization direction D3 in the odd rows and the second polarization direction D2 in the even rows. Afterward, the transmission axis A of the present embodiment is parallel to the second polarization direction D2 and perpendicular to the third polarization direction D3, and thus, the linear polarized light having the third polarization direction D3 can not pass through the polarizer film 230 so that the light-shielding region is formed in the patterned micro-retarder 250. Meanwhile, the linear polarized light having the second polarization direction D2 can almost entirely pass through the polarizer film 230 so that the light-transmissive region is formed in the patterned micro-retarder 250. Therefore, after the linear polarized light L provided by the backlight module 210 passes through the patterned micro-retarder 250, the light-shielding region is presented in the odds rows, and the light-transmissive region is presented in the even rows in the patterned micro-retarder 250 so that the viewer 20 can observe the 3D image provided by the display panel 240 with both the left and the right eyes respectively.

FIG. 4B is a schematic view illustrating a display status of the display apparatus depicted in FIG. 3A entirely switched to a planar image mode. FIG. 4B illustrates a display apparatus 200C similar to the display apparatus 200A depicted in FIG. 3A, though in the present embodiment, the modulatable parallax barrier module 220 is entirely switched to the alignment state MA, and a first polarization direction D1a has an included angle of 45 degrees with the horizontal direction. With the liquid crystal layer 226 of the modulatable parallax barrier module 220, the first polarization direction D1a of the linear polarized light L passing through the modulatable parallax barrier module 220 is twisted as a second polarization direction D2a parallel to the first alignment direction R1 to emit. Then, the extension direction of the phase retardation patterns 250A has the included angle of 0 degree with the second polarization direction D2a, and thus, after passing through the phase retardation patterns 252A, the second polarization direction D2a is not transformed so that a third polarization direction D3a parallel to the second polarization direction D2a is formed. Accordingly, the second polarization direction D2a passing through the zero retardation patterns 250B is equal to the third polarization direction D3a passing through the phase retardation patterns 250A. Now, the transmission axis A has the included angle of 45 degrees with the horizontal direction. The polarization directions D2a and D3a of the linear polarized light L passing through the patterned micro-retarder 250 are inclined toward the transmission axis A of the polarizer film 230 so as to appear in an extinction ratio state (Real polarizers are also not perfect blockers of the polarization orthogonal to their polarization axis; the ratio of the transmission of the unwanted component to the wanted component is called the extinction ratio), that is, the linear polarized light L having both the second polarization direction D2a and the third polarization direction D3a has the components parallel to the transmission axis A and thus, both can pass through the polarizer film 230. The image information now is the planar image.

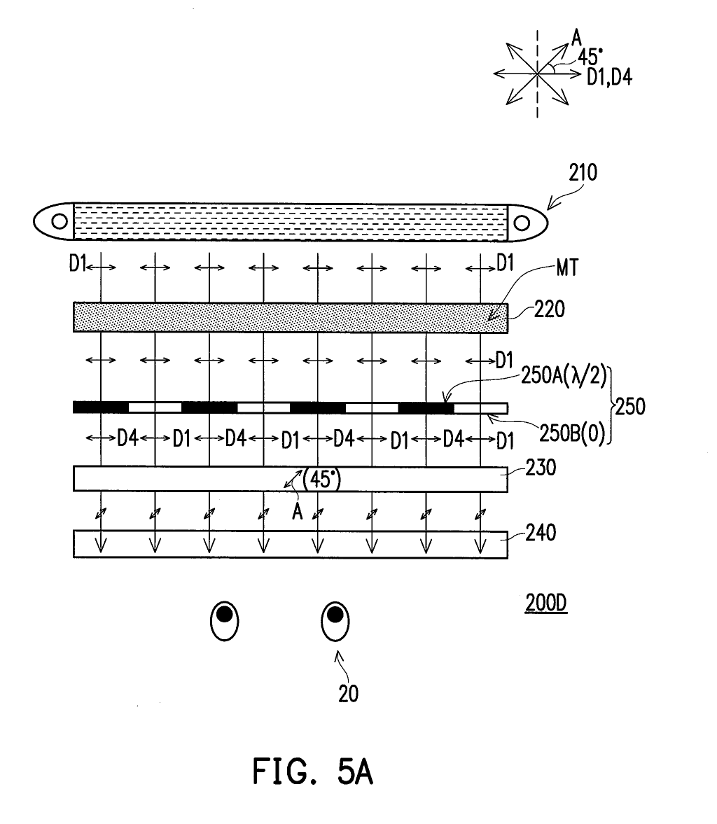

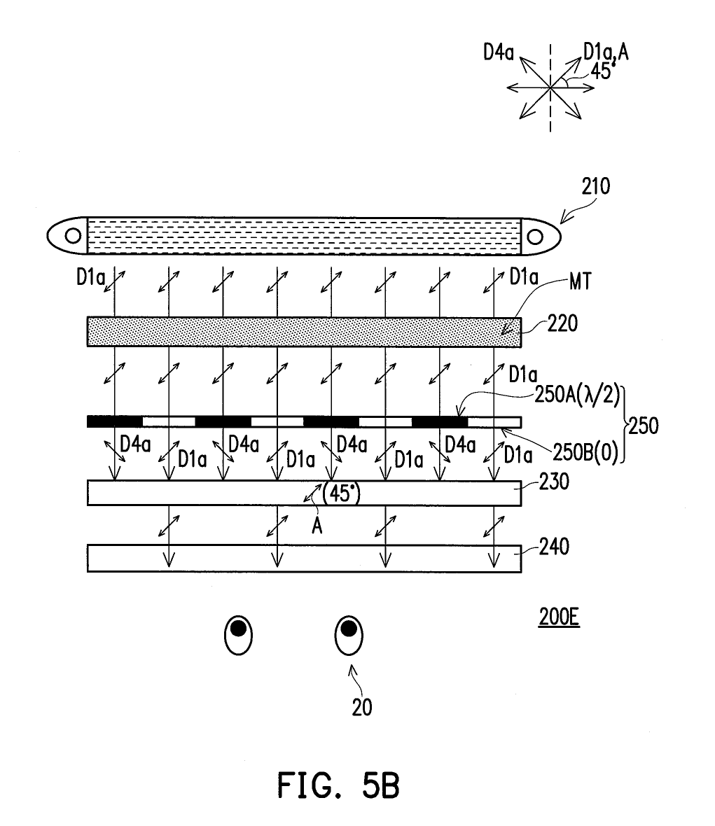

FIG. 5A is a schematic view illustrating a display status of the display apparatus depicted in FIG. 3A entirely switched to a planar image mode. FIG. 5A illustrates a display apparatus 200D similar to the display apparatus 200A depicted in FIG. 3, though in the present embodiment, the modulatable parallax barrier module 220 is entirely switched to the transparent state MT, and thus, the first polarization direction D1 of the linear polarized light L is kept in the original first polarization direction D1 to emit.

Likewise, after a portion of the linear polarized light L passes through the phase retardation patterns 250A, since the first polarization direction D1 has the included angle of 0 degree with the extension direction of the phase retardation patterns 250A, the polarization direction is not changed, and the first polarization direction D1 is then transformed to a fourth polarization direction D4 parallel to the first polarization direction D1 to emit from the patterned micro-retarder 250. On the other hand, the other portion of the linear polarized light L passing through the zero retardation patterns 250B is kept in the first polarization direction D1 to emit from the patterned micro-retarder 250. Thus, after the polarization direction of the linear polarized light L provided by the backlight module 210 passes through the transparent state MT of the modulatable parallax barrier module 220 and the patterned micro-retarder 250, the polarization direction thereof is transformed along the horizontal direction of the patterned micro-retarder 250 to the first polarization direction D1 and the fourth polarization direction D4 alternative with each other. For example, from the left side in FIG. 3A, the linear polarized light L has the fourth polarization direction D4 in the odd rows and the first polarization direction D1 in the even rows. Then, the polarization directions D1 and D4 of the linear polarized light L passing through the patterned micro-retarder 250 are inclined toward the transmission axis A of the polarizer film 230 so as to appear in the spectral state, that is, the linear polarized light L having both the fourth polarization direction D4 and the first polarization direction D1 has the components parallel to the transmission axis A so as to successfully pass through the polarizer film 230. In other words, the transmission axis A of the present embodiment has, for example, the included angle of 45 degrees with the first polarization direction D1, and thus, the linear polarized light L having the first polarization direction D1 and the fourth polarization direction D4 approximately has half component capable of passing through the polarizer film 230.

FIG. 5B is a schematic view illustrating the display apparatus depicted in FIG. 3A entirely switched to a 3D image mode according to another embodiment. FIG. 5B illustrates a display apparatus 200E similar to the display apparatus 200D depicted in FIG. 5A, though in the present embodiment, the first polarization direction D1a has the included angle of 45 degrees with the horizontal direction, and thus, the first polarization D1a of the linear polarized light L passing through the modulatable parallax barrier module 220 in the transparent state MT is kept in the original first polarization direction D1a to emit. Then, the extension direction of the phase retardation patterns 250A has the included angle of 45 degrees with the first polarization direction, and thus, after passing through the phase retardation patterns 250A, the first polarization direction D1a is transformed so that a fourth polarization direction D4a perpendicular to the first polarization direction D1a is formed. The transmission axis A of the polarizer film 230 is parallel to the first polarization direction D1a and perpendicular to the fourth polarization direction D4a. In other words, the polarization direction D4a of a portion of the linear polarized light L passing through the phase retardation patterns 250A is perpendicular to the transmission axis A of the polarizer film 230 and thus, can not pass therethrough to appear in the parallax state. Accordingly, in the present embodiment, the linear polarized light L having the first polarization direction D1a can almost entirely pass through the polarizer film 230 such that a light-transmissive region is formed, and the linear polarized light L having the fourth polarization direction D4a can not pass through the polarizer film 230 such that a light-shielding region is formed. Therefore, after the linear polarized light L provided by the backlight module 210 passes through the patterned micro-retarder 250, the light-transmissive region is presented in the odd rows and the light-shielding region is presented in the even rows of the patterned micro-retarder 250 so that the viewer 20 can observe the 3D image provided by the display panel 240 with both the left and the right eyes respectively. It is to be mentioned that, referring to FIGS. 4A, 4B, 5A and 5B simultaneously, the display brightness of the display apparatuses 200C and 200D (depicted in FIGS. 4B and 5A) entirely presenting the planar image is approximately reduced by half when passing through the polarizer film 230, and the display brightness of the display apparatuses 200B and 200E (depicted in FIGS. 4A and 5B) entirely presenting the 3D image is also approximately reduced by half when passing through the polarizer film 230. Accordingly, even though the display apparatus of the disclosure is entirely switched in different timings to either the planar image mode or the 3D image mode, the display brightness before or after switching to the planar image mode or to the 3D image mode approximately remains consistent so as to provide the viewer 20 with a comfortable viewing scenario.

In addition, particularly in the display apparatus of the disclosure, the backlight module 210 is further provided with a function of partial brightness modulation based on a number of view zones of multi-view 3D images, which is configured for modulating the difference between the brightness of the planar-image predefined display region ZA and the brightness of the 3D-image predefined display region ZB.

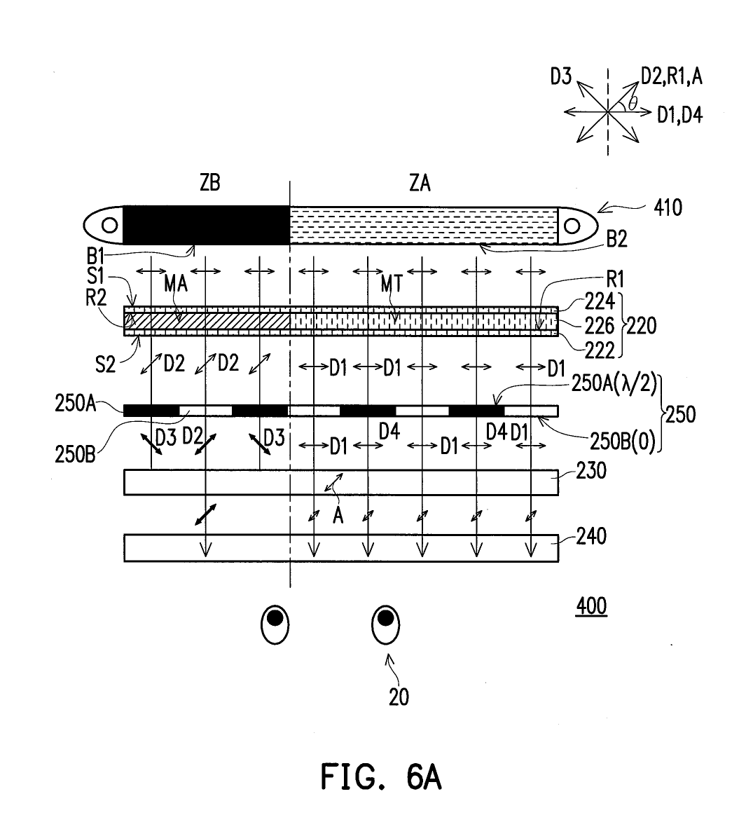

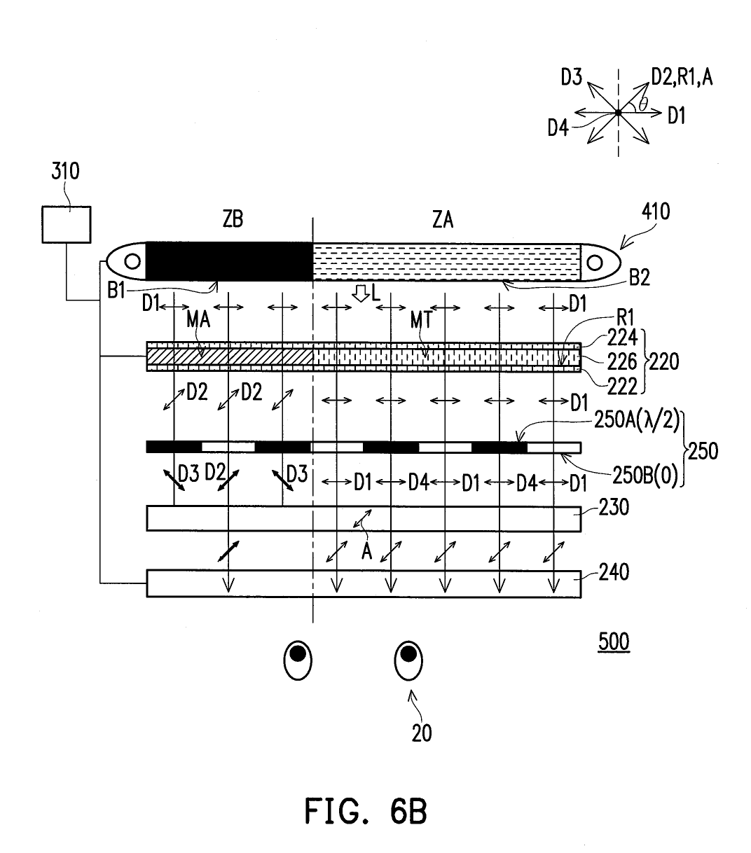

In particular, FIG. 6A is a schematic view illustrating a display apparatus according to a first embodiment of the disclosure. A display apparatus 400 of the present embodiment is similar to the display apparatus 200A depicted in FIG. 3A, in which the same elements are given the same reference symbols, though a backlight module 410 of the display apparatus 400 depicted in FIG. 6A is further provided with a function of partial brightness modulation. As shown in FIG. 6A, in the 3D-image predefined display region ZB, a block of the backlight module 410 corresponding to the modulatable parallax barrier module 220 in the alignment state MA has a first brightness B1, while in the planar-image predefined display region ZA, a block of the backlight module 410 corresponding to the modulatable parallax barrier module 220 in the transparent state MT has a second brightness B2, and the first brightness B1 is different from the second brightness B2. In other words, the backlight module 410 of the present embodiment modulates the brightness of the planar-image predefined display region ZA according to the number of the view zones of the multi-view 3D image so that the brightness of the region are modulated as brighter or darker to correspondingly balance the brightness difference between the planar-image predefined display region ZA and the 3D-image predefined display region ZB.

FIG. 6B is a schematic view according to an embodiment of the disclosure. A display apparatus 500 of the present embodiment is similar to the display apparatus 300 depicted in FIG. 3B, in which the same elements are given the same reference symbols, though the backlight module 410 of the display apparatus 500 depicted in FIG. 6B is further provided with a function of partial brightness modulation. As illustrated in FIG. 6B, the control unit 310 is electrically connected with the modulatable parallax barrier module 220, the display panel 240 and the backlight module 410. The control unit 310 controls the backlight module 410 to be presented in different brightness in blocks of the backlight module 410 respectively corresponding to the alignment state MA and the transparent state MT according to the image information of the display panel 240.

It is to be mentioned that the brightness of the backlight module 410 may also be partially modulated correspondingly based on an extension direction R3 (i.e. a light axis direction of the phase retardation patterns) of the phase retardation patterns 250A in the patterned micro-retarder 250. First, referring to FIG. 7A, a display apparatus 600A depicted in FIG. 7A is similar to the display apparatus 200A depicted in FIG. 3. In the display apparatus 600A of FIG. 7A, the extension direction R3 of the phase retardation patterns 250A in the patterned micro-retarder 250 has the included angle of 0 degree with the horizontal direction, though both the first alignment direction R1 of the modulatable parallax barrier module 220 and a transmission axis A1 of the polarizer film 230 have the included angle of 135 degrees with the horizontal direction. Therefore, the linear polarized light L having the first polarization direction D1 passing through the alignment state MA is transformed to a second polarization direction D2b parallel to the first alignment direction R1. The second polarization direction D2b (135 degrees) passing through the phase retardation patterns 250A is transformed to a third polarization direction D3b perpendicular to the second polarization direction D2b. Accordingly, an included angle between the second polarization direction D2b and the transmission axis A1 is 0 degree, and an included angle between the first polarization direction D1 and the transmission axis A1 is 135 degrees. In the present embodiment, based on an operation of the optical component, it is anticipated that a display brightness passing through the planar-image predefined display region ZA is similar to a display brightness passing through the 3D-image predefined display region ZB. When the number of the view zones of the 3D-image predefined display region ZB is two, the display brightness of the planar-image predefined display region ZA is similar to the display brightness of the 3D-image predefined display region ZB without partially modulating the brightness. When the number of the view zones of the 3D-image predefined display region ZB is more than two, the first brightness B1 of the block of the backlight module 410 corresponding to the 3D-image predefined display region ZB is modulated to be higher than the second display brightness B2 of the block of the backlight module 410 corresponding to the planar-image predefined display region ZA so that the display brightness of the planar image and the display brightness of the 3D image in the display apparatus 600B are balanced to tend to consistency.

Likewise, a display apparatus 600B depicted in FIG. 7B is similar to the display apparatus 600A depicted in FIG. 7A. The included angle between the extension direction R3 of the phase retardation patterns 250A in the patterned micro-retarder 250 and the horizontal direction is 0 degree, though in the display apparatus 600B depicted in FIG. 7B, a first polarization direction D1b is perpendicular to the extension direction R3 of the phase retardation patterns 250A, and the included angle between the first alignment direction R1 of the first alignment film 222 and the horizontal direction is 45 degrees. Based on the illustration of FIG. 7B and the optical theory as described above, it is known that in the 3D-image predefined display region ZB, the second polarization direction D2 passing through the patterned micro-retarder 250 has the included angle of 0 degree with the transmission axis A, and the third polarization direction D3 is perpendicular to the transmission axis A. In other words, in the 3D-image predefined display region ZB, the third polarization direction D3 of a portion of the linear polarized light L passing through the patterned micro-retarder 250 is perpendicular to the transmission axis A to appear in the parallax state. On the other hand, in the planar-image predefined display region ZA, both the polarization directions D1b and D4b passing through the patterned micro-retarder 250 have the included angles of 45 degrees with the transmission axis A, and the polarization directions D4b has a phase difference of 180 degrees with polarization directions D1b in this embodiment. In other embodiment, the polarization directions D4b also can have a phase difference of 0 degrees with polarization directions D1b. In other words, the polarization directions D1b and D4b passing through the patterned micro-retarder 250 are inclined toward the transmission axis A to appear in the spectral state. Likewise, based on an operation of the optical component, it is anticipated that the display brightness passing through the planar-image predefined display region ZA is similar to the display brightness passing through the 3D-image predefined display region ZB. When the number of the view zones of the 3D-image predefined display region ZB is two, the display brightness of the planar-image predefined display region ZA is similar to the display brightness of the 3D-image predefined display region ZB without partially modulating the brightness. When the number of the view zones of the 3D-image predefined display region ZB is more than two, the first brightness B1 of the block of the backlight module 410 corresponding to the 3D-image predefined display region ZB is modulated to be higher than the second display brightness B2 of a block of the backlight module 410 corresponding to the planar-image predefined display region ZA so that the display brightness of the planar image and the display brightness of the 3D image in the display apparatus 600B are balanced to tend to consistency.

A display apparatus 600C depicted in FIG. 7C is similar to the display apparatus 600B depicted in FIG. 7B, though the transmission axis A1 of the polarizer film 230 is changed from 45 degrees to 135 degrees. As the same result of the display apparatus 600B depicted in FIG. 7B, based on an operation of the optical component, it is anticipated that the display brightness passing through the planar-image predefined display region ZA is similar to the display brightness passing through the 3D-image predefined display region ZB. When the number of the view zones of the 3D-image predefined display region ZB is two, the display brightness of the planar-image predefined display region ZA is similar to the display brightness of the 3D-image predefined display region ZB without partially modulating the brightness. When the number of the view zones of the 3D-image predefined display region ZB is more than two, the first brightness B1 of the block of the backlight module 410 corresponding to the 3D-image predefined display region ZB is modulated to be higher than the second display brightness B2 of the block of the backlight module 410 corresponding to the planar-image predefined display region ZA so that the display brightness of the planar image and the display brightness of the 3D image in the display apparatus 600B are balanced to tend to consistency.

Likewise, a display apparatus 600D depicted in FIG. 7D is similar to the display apparatus 600A depicted in FIG. 7A. The included angle between the extension direction R3 of the phase retardation patterns 250A in the patterned micro-retarder 250 and the horizontal direction is 0 degree, though in the display apparatus 600D depicted in FIG. 7D, the included angle between the first polarization direction D1a and the horizontal direction is 45 degrees, the included angle between the transmission axis A of the polarizer film 230 and the horizontal direction is also 45 degrees, and the included angle between the first alignment direction R1 of the first alignment film 222 and the horizontal direction is 0 degree. Under such configuration, a region of light passing through the transparent state MT is the 3D-image predefined display region ZB, and a region of light passing through the alignment state MA is the planar-image predefined display region ZA. After passing through the modulatable parallax barrier module 220 and the patterned micro-retarder 250, the polarization direction of the linear polarized light L having the first polarization direction D1a is changed as shown in FIG. 7D. In short, in the 3D-image predefined display region ZB, the polarization direction D4a of a portion of the linear polarized light L passing through the patterned micro-retarder 250 is perpendicular to the transmission axis A of the polarizer film 230 to appear in the parallax state, while in the planar-image predefined display region ZA, the polarization directions D2a and D3a of the linear polarized light L passing through the patterned micro-retarder 250 are inclined toward the transmission axis A to appear in the spectral state. Likewise, based on the operation of the optical component, it is anticipated that the display brightness passing through the planar-image predefined display region ZA is similar to the display brightness passing through the 3D-image predefined display region ZB. When the number of the view zones of the 3D-image predefined display region ZB is two, the display brightness of the planar-image predefined display region ZA is similar to the display brightness of the 3D-image predefined display region ZB without partially modulating the brightness. When the number of the view zones of the 3D-image predefined display region ZB is more than two, the first brightness B1 of the block of the backlight module 410 corresponding to the 3D-image predefined display region ZB is modulated to be higher than the second display brightness B2 of the block of the backlight module 410 corresponding to the planar-image predefined display region ZA so that the display brightness of the planar image and the display brightness of the 3D image in the display apparatus 600D are balanced to tend to consistency.

A display apparatus 600E depicted in FIG. 7E is similar to the display apparatus 600A depicted in FIG. 7A, though in the display apparatus 600D of FIG. 7E, an included angle between a first polarization D1c and the horizontal direction is 135 degrees, the included angle between the transmission axis A1 of the polarizer film 230 and the horizontal direction is also 135 degrees, and the included angle between the first alignment direction R1 of the first alignment film 222 and the horizontal direction is 0 degree. Under such configuration, the region of light passing through the transparent state MT is the 3D-image predefined display region ZB, and the region of light passing through the alignment state MA is the planar-image predefined display region ZA. After passing through the modulatable parallax barrier module 220 and the patterned micro-retarder 250, the polarization direction of the linear polarized light L having the first polarization direction D1c is changed as shown in FIG. 7E. In short, in the 3D-image predefined display region ZB, the polarization direction D4c of a portion of the linear polarized light L passing through the patterned micro-retarder 250 is perpendicular to the transmission axis A1 of the polarizer film 230 to appear in the parallax state, while in the planar-image predefined display region ZA, the polarization directions D2a and D3a of the linear polarized light L passing through the patterned micro-retarder 250 are inclined toward the transmission axis A1 to appear in the spectral state. Likewise, based on the operation of the optical component, it is anticipated that the display brightness passing through the planar-image predefined display region ZA is similar to the display brightness passing through the 3D-image predefined display region ZB. When the number of the view zones of the 3D-image predefined display region ZB is two, the display brightness of the planar-image predefined display region ZA is similar to the display brightness of the 3D-image predefined display region ZB without partially modulating the brightness. When the number of the view zones of the 3D-image predefined display region ZB is more than two, the first brightness B1 of the block of the backlight module 410 corresponding to the 3D-image predefined display region ZB is modulated to be higher than the second display brightness B2 of the block of the backlight module 410 corresponding to the planar-image predefined display region ZA so that the display brightness of the planar image and the display brightness of the 3D image in the display apparatus 600E are balanced to tend to consistency.

FIG. 7F is a schematic view illustrating an embodiment of a multi-view 3D display. Herein, an included angle between an extension direction R3a of the phase retardation patterns 250A in the patterned micro-retarder 250 and the horizontal direction is 18.43 degrees. In addition, angles of a first polarization direction D1d of the linear polarized light L in the display apparatus, the second alignment direction R2 of the second alignment film 224 of the modulatable parallax barrier module 220, the first alignment direction R1 of the first alignment film 222 of the modulatable parallax barrier module 220, the extension direction R3a of the phase retardation patterns 250A and a transmission axis A2 with the horizontal direction are as shown in FIG. 7G.

With reference to FIGS. 7F and 7G, a display apparatus 600F depicted in FIG. 7F is similar to the display apparatus 200A depicted in FIG. 3A, though in the display apparatus 600F of the FIG. 7A, the included angle between the extension direction R3a of the phase retardation patterns 250A and the horizontal direction is 18.43 degrees, the included angle between the first polarization direction D1d of the linear polarized light L and the horizontal direction is 18.43 degrees, the included angle between the first alignment direction R1 and the horizontal direction is 63.43 degrees, the included angle between a second polarization direction D2c and transmission axis A2 is 0 degree, and the included angle between the first polarization D1d and the transmission axis A2 is 45 degrees. In the 3D-image predefined display region ZB, the polarization direction of the linear polarized light L passing through the alignment state MA is rotated to the first alignment direction R1. Thus, after passing through the modulatable parallax barrier module 220 in the alignment state MA, the polarization direction of the linear polarized light L having the first polarization D1d and emitting from the backlight module 410 is transformed to the second polarization direction D2c having the included angle of 63.43 degrees with the horizontal direction. Then, since the included angle between the second polarization direction D2c and the extension direction R3a of the phase retardation patterns 250A is 45 degrees, the polarization direction of the linear polarized light L passing through the phase retardation patterns 250A is rotated by 90 degrees as a third polarization direction D3c having the included angle of 153.43 degrees with the horizontal direction. In the planar-image predefined display region ZA, since the first polarization direction D1d has the included angle of 0 degree with the extension direction R3a of the phase retardation patterns 250A, the polarization direction of the linear polarized light L passing through the phase retardation patterns 250A is not changed so that a fourth polarization direction D4d of the linear polarized light L passing through the phase retardation patterns 250A is equal to the first polarization direction D1d and has an included angle of 18.43 degrees with the horizontal direction.

In short, in the 3D-image predefined display region ZB, the polarization direction D3c of a portion of the linear polarized light L passing through the patterned micro-retarder 250 is perpendicular to the transmission axis A2 of the polarizer film 230 to appear in the parallax state. In the planar-image predefined display region ZA, the polarization directions D1d and D4d of the linear polarized light L passing through the patterned micro-retarder 250 are inclined toward the transmission axis A2 of the polarizer film 230 to appear in the spectral state. In the present embodiment, based on the operation of the optical component, it is anticipated that the display brightness passing through the planar-image predefined display region ZA is similar to the display brightness passing through the 3D-image predefined display region ZB. However, this example illustrates an embodiment where the display region for the 3D image is multi-view, and thus, a ratio of the light-shielding region is increased in the display region for the 3D image. The second brightness B2 of the block of the backlight module 410 corresponding to the planar-image predefined display region ZA is modulated to be lower than the first brightness B1 of the block of the backlight module 410 corresponding to the 3D-image predefined display region ZB so that the display brightness of the planar image and the display brightness of the 3D image in the display apparatus 600F are balanced to tend to consistency.

Besides, a display apparatus 600G depicted in FIG. 7H is similar to the display apparatus 600F depicted in FIG. 7F, though an included angle between a transmission axis A3 of the polarizer film 230 and the horizontal direction is 153.43 degrees, an included angle between a first polarization direction D1e of the linear polarized light L and the horizontal direction is 108.43 degrees, and the included angle between the first alignment direction R1 and the horizontal direction is 153.43 degrees. Thus, a second polarization direction D2d of the linear polarized light L passing through the alignment state MA has an included angle of 135 degrees with the extension direction R3a of the phase retardation patterns 250A so that the polarization direction of the linear polarized light L passing through the phase retardation patterns 250A is rotated to a third polarization direction D3d having an included angle of 63.43 degrees with the horizontal direction. In short, in the 3D-image predefined display region ZB, the polarization direction D3d of a portion of the linear polarized light L passing through the patterned micro-retarder 250 is perpendicular to the transmission axis A3 of the polarizer film 230 to appear in the parallax state. In the planar-image predefined display region ZA, the polarization directions D1e and D4e (108.43 degrees) of the linear polarized light L passing through the patterned micro-retarder 250 are inclined toward the transmission axis A3 (153.43 degrees) of the polarizer film 230 to appear in the spectral state. In the present embodiment, based on the operation of the optical component, it is anticipated that the display brightness passing through the planar-image predefined display region ZA is similar to the display brightness passing through the 3D-image predefined display region ZB. However, this example illustrates an embodiment where the display region for the 3D image is multi-view, and thus, the ratio of the light-shielding region is increased in the display region for the 3D image. Thus, the second brightness B2 of the block of the backlight module 410 corresponding to the planar-image predefined display region ZA is modulated to be lower than the first brightness B1 of the block of the backlight module 410 corresponding to the 3D-image predefined display region ZB so that the display brightness of the planar image and the display brightness of the 3D image in the display apparatus 600G are balanced to tend to consistency.

Besides, a display apparatus 600H depicted in FIG. 7I is similar to the display apparatus 600F depicted in FIG. 7F, though in the display apparatus 600H of FIG. 7I, an included angle between a first polarization direction D1f and the horizontal direction is 63.43 degrees, and the included angle between the first alignment direction R1 and the horizontal direction is 108.43 degrees. Under such configuration, the region of light passing through the transparent state MT is the 3D-image predefined display region ZB, and the region of light passing through the alignment state MA is the planar-image predefined display region ZA. After passing through the modulatable parallax barrier module 220 and the patterned micro-retarder 250, the polarization direction of the linear polarized light L having the first polarization direction D1f (63.43 degrees) is changed as shown in FIG. 7I. In the 3D-image predefined display region ZB, the linear polarized light L having the polarization direction D1f has the included angle of 45 degrees with the extension direction R3a of the phase retardation patterns 250A, and thus, the polarization of the linear polarized light L passing through the phase retardation patterns 250A is rotated by 90 degrees and transformed to a fourth polarization direction D4f having an included angle of 153.43 degrees with the horizontal direction. In the planar-image predefined display region ZA, the linear polarized light L having a second polarization direction D2e is perpendicular to the extension direction R3a of the phase retardation patterns 250A, and thus, the polarization of the linear polarized light L having the second polarization direction D2e is rotated by 180 degrees when passing through the phase retardation patterns 250A, which is equivalent to no rotation. Accordingly, after the linear polarized light L having the second polarization direction D2e passes through the phase retardation patterns 250A, the polarization direction thereof is transformed to a third polarization direction D3e without changing the polarization direction. In short, in the 3D-image predefined display region ZB, the polarization direction Df4 of a portion of the linear polarized light L passing through the phase retardation patterns 250A is perpendicular to the transmission axis A2 of the polarizer film 230 to appear in the parallax state, while in the planar-image predefined display region ZA, the polarization directions D2e and D3e of the linear polarized light L are inclined toward the transmission axis A2 to appear in the spectral state. Likewise, based on the operation of the optical component, it is anticipated that the display brightness passing through the planar-image predefined display region ZA is similar to the display brightness passing through the 3D-image predefined display region ZB. However, this example illustrates an embodiment where the display region for the 3D image is multi-view, and thus, the ratio of the light-shielding region is increased in the display region for the 3D image. Thus, the second brightness B2 of the block of the backlight module 410 corresponding to the planar-image predefined display region ZA is modulated to be lower than the first brightness B1 of the block of the backlight module 410 corresponding to the 3D-image predefined display region ZB so that the display brightness of the planar image and the display brightness of the 3D image in the display apparatus 600H are balanced to tend to consistency.

On the other hand, a display apparatus 600I depicted in FIG. 7J is similar to the display apparatus 600G depicted in FIG. 7H, though in the display apparatus 600I of FIG. 7J, an included angle between a first polarization direction D1g and the horizontal direction is 153.43 degrees, and the included angle between the first alignment direction R1 and the horizontal direction is 18.43 degrees. Under such configuration, the region of light passing through the transparent state MT is the 3D-image predefined display region ZB, and the region of light passing through the alignment state MA is the planar-image predefined display region ZA. After passing through the modulatable parallax barrier module 220 and the patterned micro-retarder 250, the polarization direction of the linear polarized light L having the first polarization direction D1g is changed as shown in FIG. 7J. In the 3D-image predefined display region ZB, the linear polarized light L having the first polarization direction D1g has the included angle of 135 degrees with the extension direction R3a of the phase retardation patterns 250A, and thus, the polarization of the linear polarized light L passing through the phase retardation patterns 250A is rotated by 270 degrees and transformed to a fourth polarization direction D4g having an included angle of 63.43 degrees with the horizontal direction. In the planar-image predefined display region ZA, the linear polarized light L having a second polarization direction D2f has an included angle of 0 degree with the extension direction R3a of the phase retardation patterns 250A, and thus, after passing through the phase retardation patterns 250A, the polarization of the linear polarized light L having the second polarization direction D2f is not rotated. Accordingly, after the linear polarized light L having the second polarization direction D2f passes through the phase retardation patterns 250A, the polarization direction thereof is transformed to a third polarization direction D3f without changing the polarization direction. In short, in the 3D-image predefined display region ZB, a polarization direction D4g of a portion of the linear polarized light L passing through the phase retardation patterns 250A is perpendicular to the transmission axis A2 of the polarizer film 230 to appear in the parallax state, while in the planar-image predefined display region ZA, the polarization directions D2f and D3f of the linear polarized light L are inclined toward the transmission axis A2 to appear in the spectral state.

### Second Embodiment

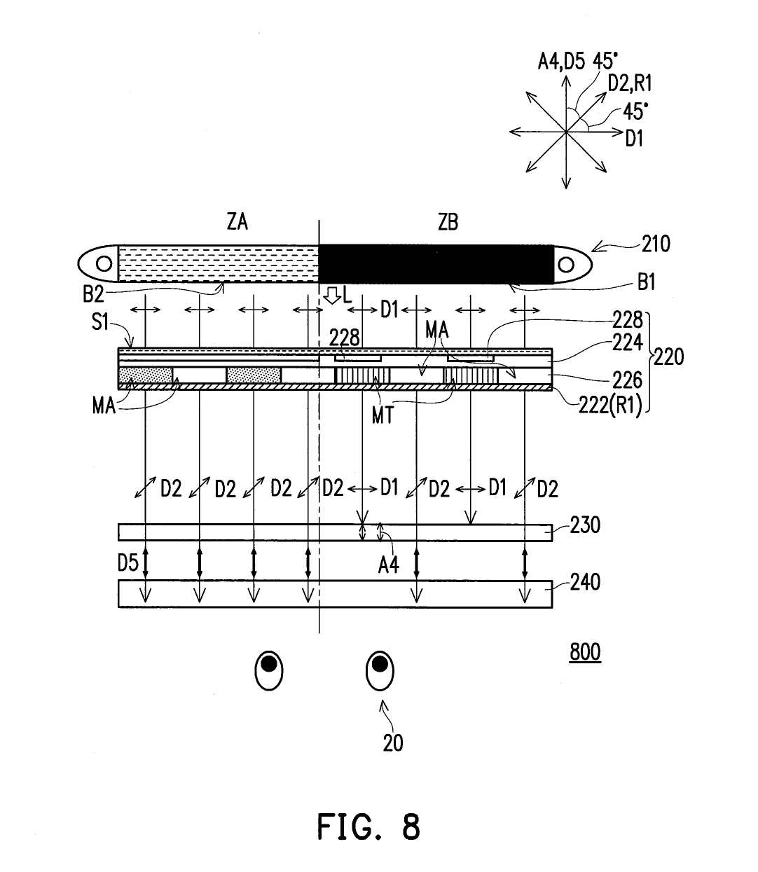

FIG. 8 is a schematic view of a display apparatus simultaneously presenting a planar image and a 3D image according to a second embodiment of the disclosure, in which a display apparatus 800 has the planar-image predefined display region ZA and the 3D-image predefined display region ZB.

As shown in FIG. 8, the display apparatus 800 is different from that of the first embodiment. The display apparatus 800 of the present embodiment is not provided with the patterned micro-retarder 250 illustrated in FIG. 2 through 7. In stead, a plurality of stripe electrodes 228 separated from each other is disposed in the modulatable parallax barrier module 220 so that the alignment state MA and the transparent state MT is formed alternatively with each other in the corresponding liquid crystal layer 226 so as to be configured as a parallax barrier for presenting the 3D image.

In detail, beside the elements as previously illustrated in FIG. 3A, the modulatable parallax barrier module 220 of the present embodiment further includes a plurality of stripe electrodes 228. Referring to FIG. 8, the second alignment film 224 is disposed at the light-incident side S1 of the modulatable parallax barrier module 220, the liquid crystal layer 226 is disposed between the first alignment film 222 and the second alignment film 224, and the plurality of stripe electrodes 228 are disposed on the second alignment film 224. Certainly, a complete electrode layer (not shown) may also be disposed on the first alignment film 222 of the present embodiment, and by controlling a voltage at two sides of the liquid crystal layer 226 and the complete electrode layer, the liquid crystal layer 226 is presented in the transparent state MT. The liquid crystal layer 226 where the stripe electrodes 228 are precluded is presented in the alignment state MA.

In particular, in the planar-image predefined display region ZA of the display apparatus 800, the complete electrode layer may be respectively disposed on the first alignment film 222 and the second alignment film 224 at the two sides of the liquid crystal layer 226. When presenting the planar image, the liquid crystal layer 226 in the planar-image predefined display region ZA is presented in the alignment state MA. In short, referring to FIG. 8, the first polarization direction D1 of the linear polarized light L passing through the liquid crystal layer 226 is twisted as the second polarization direction D2 parallel to the first alignment direction R1. Afterward, the linear polarized light L emitting from the modulatable parallax barrier module 220 has the second polarization direction D2. Then, the linear polarized light L having the second polarization direction D2 has a component parallel to a transmission axis A4 so that the linear polarized light L in the planar-image predefined display region ZA can pass through the polarizer film 230 successfully to present the planar image.

On the other hand, in the 3D-image predefined display region ZB of the display apparatus 800, the plurality of stripe electrodes 228 are aligned in interval on the second alignment film 224 (in other embodiments, the plurality of stripe electrodes 228 may also be aligned in interval on the first alignment film 222), and thus, the patterned transparent state MT and the alignment state MA are presented on the liquid crystal layer 226 based on the disposing position of the stripe electrodes 228. In detail, in the region of the 3D-image predefined display region ZB where the stripe electrodes are disposed, the liquid crystal layer 226 is presented in the alignment state by applying the voltage on the stripe electrodes at the two sides of the liquid crystal layer 226 and the complete electrode layer. That is to say, the region where the stripe electrodes 228 are disposed is considered as the zero retardation patterns 250B. On the other hand, in the region of the 3D-image predefined display region ZB where the stripe electrodes 228 are not disposed, the liquid crystal molecules at the two side of the liquid crystal layer 226 are respectively aligned based on the first alignment direction R1 and the alignment direction R2 so that the alignment state MA is presented to contribute a retardation of the liquid crystal molecules being naturally twisted. That is to say, the region where the stripe electrodes 228 are not disposed is considered as the phase retardation patterns 250A. Therefore, the light-shielding region and the light-transmissive region are formed based on the disposing position of the stripe electrodes 228 so as to be configured as the parallax barriers for the 3D image.

In short, referring to FIG. 8, after a portion of the linear polarized light L passes through the region where the stripe electrodes 228 are not disposed, the first polarization direction D1 of the linear polarized light L passing through the liquid crystal layer 226 in the alignment state is twisted as the second polarization direction D2 parallel to the first alignment direction R1. On the other hand, after the other portion of the linear polarized light L passes through the region of the modulatable parallax barrier module 220 where the stripe electrodes 228 are disposed, the first polarization direction D1 of the linear polarized light L passing through the liquid crystal layer 226 in the transparent state MT is kept in the original first polarization direction D1. Accordingly, after passing through the modulatable parallax barrier module 220, the polarization direction of the linear polarized light L provided by the backlight module 210 is transformed along the horizontal direction of the modulatable parallax barrier module 220 to the first polarization direction D1 and the second polarization direction D2 alternative with each other. Afterward, in the present embodiment, the first polarization direction D1 is perpendicular to the transmission axis A4 of the polarizer film 230, and thus, the linear polarized light L having the first polarization direction D1 can not pass through the polarizer film 230 so that the light-shielding region is formed. On the other hand, the second polarization direction D2 has the component parallel to the transmission axis A4 of the polarizer film 230, and thus, the linear polarized light L having the second polarization direction D2 can pass through the polarizer film 230 so that a light-transmissive region is formed. Therefore, after the linear polarized light L provided by the backlight module 210 passes through the modulatable parallax barrier module 220, the light-transmissive region is presented where the stripe electrodes 228 are disposed, and the light-shielding region is presented where the stripe electrodes 228 are not disposed so that the viewer 20 can observe the three-dimensional image provided by the display panel 240 with both the left and the right eyes respectively.

A control method of the display apparatus 80 depicted in FIG. 8 will be briefly illustrated hereinafter, which includes steps as follows. Whether the image information is a text, a planar image or a three-dimensional image is determined. When the image information is a text or a planar image, the modulatable parallax barrier module 220 is entirely switched to the alignment state MA. When the image information is a 3D image, the region of the modulatable parallax barrier module 220 where the stripe electrodes 228 are disposed is entirely switched to the transparent state MT.

Likewise, in the present embodiment, as in the first embodiment, the control unit (not shown) and the backlight module 210 having a function of partial brightness modulation are further included. In detail, the control unit 310 is electrically connected with the backlight module 210, the modulatable parallax barrier module 220 and the display panel 240. The control unit 310 controls the modulatable parallax barrier module 220 to be partially or entirely switched to either the alignment state MA or the transparent state MT according to the image information of the display panel 240 and controls the blocks respectively corresponding to the transparent state MT and the alignment state MA to be presented in different brightness. For example, the predefined display region ZA for the 3D image has the first brightness B 1, and the predefined display region ZB for the planar image has the second brightness B2.

On the other hand, with the backlight module 210 further provided with the function of partial brightness modulation, the difference between the brightness of the planar-image predefined display region ZA and the brightness of the 3D-image predefined display region ZB is modulated according to the number of view zones of multi-view 3D images, which will not described repeatedly hereinafter. In the mean time, when the display apparatus 800 includes the control unit 310 and the backlight module 210 provided with the function of partial brightness modulation, a control method of the display apparatus 800 includes steps as follows, for example. When the image information is a text or a planar image, the control unit 310 controls the modulatable parallax barrier module 220 to be entirely switched to the alignment state MA and controls the backlight module 210 to execute the brightness balance. When the image information is a 3D image, the control unit 310 controls the stripe electrodes 228 disposed in the modulatable parallax barrier module 220 so that the region of the modulatable parallax barrier module 220 where the stripe electrodes are disposed is switched to the transparent state MT. The control unit 310 partially modulates the brightness of the backlight module 210.

### The Third Embodiment

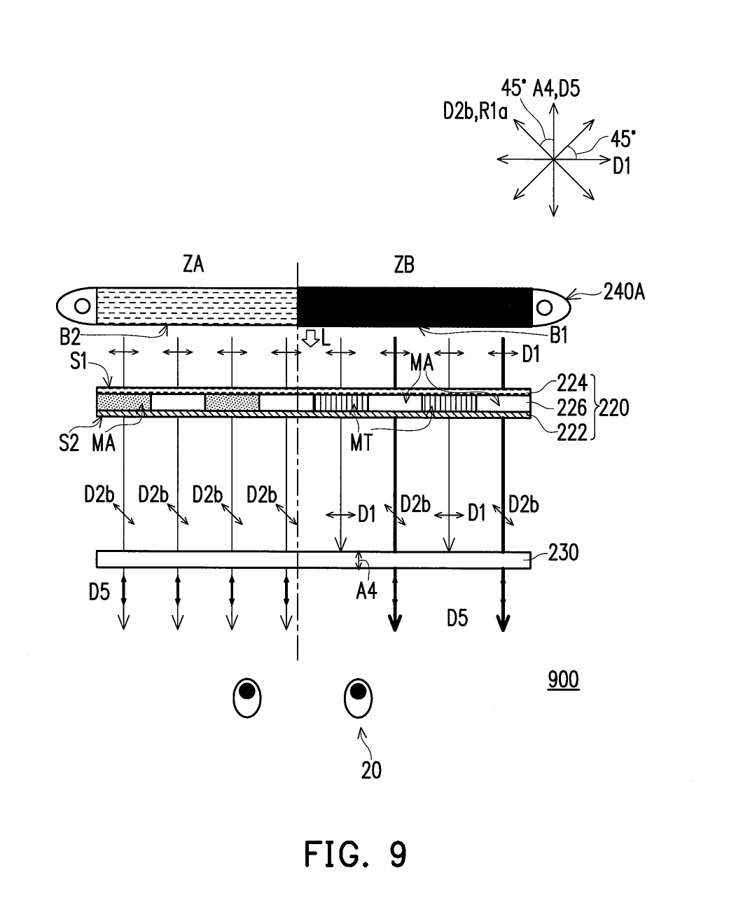

FIG. 9 is a schematic view of a display apparatus simultaneously presenting a planar image and a 3D image according to a third embodiment of the disclosure, in which a display apparatus 900 has the planar-image predefined display region ZA and the 3D-image predefined display region ZB.

As illustrated in FIG. 9, the display apparatus 900 is differing from that in the first embodiment. In the display apparatus 900 of the present embodiment, the display panel 240 and the backlight module 410 are first integrated (or a display panel 240A provided with auto-emission) to then collectively emit the linear polarized light L having the image information to the modulatable parallax barrier module 220. As the same in the first and second embodiments, in the display apparatus 900 of the present embodiment, the modulatable parallax barrier module 220 is directly configured as the parallax barrier.

In detail, the display apparatus 900 of the present embodiment includes an auto-emitting display panel 240A (or an apparatus integrated with the display panel 240 and the backlight module 410), the modulatable parallax barrier module 220 and the polarizer film 230. The auto-emitting display panel 240A is adapted to providing a linear polarized light L having the first polarization direction D1. The modulatable parallax barrier module 220 is disposed on the auto-emitting display panel 240A. The modulatable parallax barrier module 220 has the first alignment film 222 at the light-emitting side S2, and the first alignment film has the first alignment direction R1. The modulatable parallax barrier module 220 has the alignment state MA and the transparent state MT. The linear polarized light L passing through the transparent state MT of the modulatable parallax barrier module 220 is kept in the first polarization direction D1, and the linear polarized light L passing through the modulatable parallax barrier module 220 in the alignment state MA is transformed to the second polarization direction D2b parallel to the first alignment direction R1. The polarizer film 230 is disposed on the first alignment film 222 and has the transmission axis A4. The alignment direction of the first alignment film 222 is not parallel to the transmission axis A4. The modulatable parallax barrier module 220 is selectively switched to either the alignment state MA or the transparent state MT according to the image information.

To be detailed, in the present embodiment, the modulatable parallax barrier module 220 includes the first alignment film 222, the second alignment film 224, the liquid crystal layer 226 and the stripe electrodes 228 (not shown). The second alignment film 224 is disposed at the light-incident side S1 of the modulatable parallax barrier module 220. The liquid crystal layer 226 is disposed between the first alignment film 222 and the second alignment film 224. The stripe electrodes 228 are disposed on either the first alignment film 222 or the second alignment film 224. Thus, as the same as the modulatable parallax barrier module 220 depicted in FIG. 8, in the modulatable parallax barrier module 220 of the present embodiment, a part of the modulatable parallax barrier module 220 where the stripe electrodes 228 are disposed is presented in the transparent state MT, and the other part of the modulatable parallax barrier module 220 where the stripe electrodes are not disposed is presented in the alignment state MA.

In short, in the planar-image predefined display region ZA of the display apparatus 900 of the present embodiment, the complete electrode layer may be respectively disposed on the first alignment film 222 and the second alignment film 224 at the two sides of the liquid crystal layer 226. The liquid crystal layer 226 in the planar-image predefined display region ZA is presented in the alignment state MA, the first polarization direction D1 of the linear polarized light L passing through the liquid crystal layer 226 presented in the alignment state MA is twisted as the second polarization direction D2b. Then, the linear polarized light L having the second polarization direction D2b has the component parallel to the transmission axis A4 so that the linear polarized light L in the planar-image predefined display region ZA can pass through the polarizer film 230 successfully to present the planar image.

On the other hand, in the region of the 3D-image predefined display region ZB of the display apparatus 900 depicted in FIG. 9, the liquid crystal layer 226 is presented in the transparent state MT by applying a voltage on the stripe electrodes 228 at the two sides of the liquid crystal layer 226 and the complete electrode layer. Thus, the region where the stripe electrodes 228 are disposed is considered as the zero retardation patterns 250B. On the other hand, in the region of the 3D-image predefined display region ZB where the stripe electrodes are not disposed, the liquid crystal layer 226 is presented in the alignment state MA to contribute a retardation of the liquid crystal molecules being naturally twisted. Thus, the region where the stripe electrodes 228 are not disposed is considered as the phase retardation patterns 250A. Therefore, a light-shielding region and a light-transmissive region are formed based on the disposing position of the stripe electrodes 228 in the modulatable parallax barrier module 220 so as to be configured as the parallax barriers for the 3D image. In short, after the linear polarized light L having the image information provided by the auto-emitting display panel 240A passes through the modulatable parallax barrier module 220, the light-transmissive region is presented where the stripe electrodes 228 are disposed, and the light-shielding region is presented where the stripe electrodes 228 are not disposed so that the viewer 20 can observe the 3D image provided by the auto-emitting display panel 240A with both the left and the right eyes respectively.

Certainly, in the present embodiment, the auto-emitting display panel 240A may also be provided with the function of partial brightness modulation. As illustrated in FIG. 9, the brightness of the region of the auto-emitting display panel 240A corresponding to the redefined display region ZB for the 3D image may be correspondingly modulated so that the difference between the brightness of the planar-image predefined display region ZA and the brightness of the 3D-image predefined display region ZB is modulated according to the number of view zones of multi-view 3D images. For example, the region of the auto-emitting display panel 240A corresponding to the redefined display region ZB for the 3D image is provided with the first brightness B1, and the region of the auto-emitting display panel 240A corresponding to the redefined display region ZA for the planar image is provided with the second brightness B2. When the display brightness passing through the planar-image predefined display region ZA is higher than the display brightness of the 3D-image predefined display region ZB, the display brightness of the display apparatus 900 are balanced by modulating the first brightness B1 of the auto-emitting display panel 240A to be higher than the second brightness B2 thereof so that the display brightness of the planar image tends to be consistent with the display brightness of the 3D image, and vice versa. A description of the same elements is therefore omitted.

Certainly, in the display apparatus 900 of the present embodiment, the control unit (not shown) may be further included. The control unit is electrically connected with the modulatable parallax barrier module 220, the auto-emitting display panel 240A (or the apparatus integrated with the display panel 240 and backlight module 410). The control unit 310 controls the modulatable parallax barrier module 220 to be partially or entirely switched to either the alignment state MA or the transparent state MT according to the image information in the linear polarized light L and controls the blocks of the backlight module 410 corresponding to either the alignment state MA or the transparent state MT to present in different brightness.

In view of the foregoing, by the display apparatus of the disclosure and the control method thereof, the modulatable parallax barrier module can be controlled according to the image information to be displayed by the display panel so that the modulatable parallax barrier module is switched to either the alignment state or the transparent state correspondingly. Besides, the alignment film of the modulatable parallax barrier module has either one of the alignment directions inclined toward an alignment film of the transmission axis of the polarizer film, and thus, the brightness presenting the planar image and the brightness presenting the 3D image intend to consistency. Even though the planar image and the 3D image are simultaneously presented in the display apparatus, the planar and the 3D images with more consistent brightness can be provided.

It will be apparent to those skilled in the art that various modifications and variations can be modulated to the structure of the disclosed embodiments without departing from the scope or spirit of the disclosure. In view of the foregoing, it is intended that the disclosure covers modifications and variations of this disclosure provided they fall within the scope of the following claims and their equivalents.

What is claimed is:

1. A display apparatus, comprising:
a backlight module, adapted to providing a linear polarized light having a first polarization direction;
a modulatable parallax barrier module, disposed on the backlight module and having an alignment state and a transparent state, wherein the modulatable parallax barrier module has a first alignment film at a light-emitting side and a second alignment film at a light-incident side, and the first alignment film has a first alignment direction, wherein the linear polarized light passing through the modulatable parallax barrier module in the transparent state is kept in the first polarization direction, and the linear polarized light passing through the modulatable parallax barrier module in the alignment state is transformed to a second polarization direction parallel to the first alignment direction;
a polarizer film, disposed on the first alignment film and having a transmission axis, wherein the transmission axis is inclined toward either one of the first polarization direction and the second polarization direction; and
a display panel, configured to provide an image information, wherein, the modulatable parallax barrier module is selectively switched to either the alignment state or the transparent state according to the image information.

2. The display apparatus as recited in claim 1, further comprising a patterned micro-retarder disposed between the modulatable parallax barrier module and the polarizer film, wherein the patterned micro-retarder has a plurality of phase retardation patterns and a plurality of zero retardation patterns, the plurality of phase retardation patterns and the plurality of zero retardation patterns are aligned alternatively with each other, and a retardation of each of the plurality of phase retardation patterns is λ/2.

3. The display apparatus as recited in claim 2, wherein after the linear polarized light passes through the modulatable parallax barrier module in the alignment state, the polarization direction of a portion of the linear polarized light passing through the plurality of phase retardation patterns is transformed to a polarization direction perpendicular to the transmission axis of the polarizer film, and the other portion of the linear polarized light passing through the plurality of zero retardation patterns is kept in the polarization direction, and wherein the polarization direction of a portion of the linear polarized light passing through the patterned micro-retarder is perpendicular to the transmission axis of the polarizer film and can not be passed therethrough so as to be presented in a parallax state, the transmission axis of the polarizer film is perpendicular to either one of the first polarization direction and the second polarization direction, and the image information is a three-dimensional (3D) image.

4. The display apparatus as recited in claim 2, wherein after the linear polarized light passes through the modulatable parallax barrier module in the transparent state, the first polarization direction of a portion of the linear polarized light passing through the plurality of phase retardation patterns is transformed to a third polarization direction perpendicular to the first polarization direction, and the polarization direction of the other portion of the linear polarized light passing through the plurality of zero retardation patterns is kept in the first polarization direction, wherein the polarization direction of a portion of the linear polarized light passing through the patterned micro-retarder is perpendicular to the transmission axis of the polarizer film so as to be presented in a parallax state, the transmission axis of the polarizer film is perpendicular to either one of the first polarization direction and the third polarization direction, and the image information is a 3D image.

5. The display apparatus as recited in claim 2, wherein after the linear polarized light passes through the plurality of phase retardation patterns, the polarization direction of the linear polarized light is transformed by the plurality of phase retardation patterns to a polarization direction parallel to the polarization direction without passing through the phase retardation patterns, and the other portion of the linear polarized light passing through the plurality of zero retardation patterns is kept in the first polarization direction, wherein the polarization directions of the linear polarized light passing through and without passing through the patterned micro-retarder are inclined toward the axis of the polarizer film to appear in a balanced spectral state, both of the polarization directions of the linear polarized light passing through and without passing through the patterned micro-retarder have components parallel to the transmission axis so as to entirely pass through the polarizer film, and the image information is a planar image.

6. The display apparatus as recited in claim 1, wherein an included angle between either one of the first polarization direction or the second polarization direction and the transmission axis is 45 degrees, 135 degrees, 225 degrees or 315 degrees.

7. The display apparatus as recited in claim 1, wherein the modulatable parallax barrier module further comprises a liquid crystal layer disposed between the first alignment film and the second alignment film.

8. The display apparatus as recited in claim 7, wherein a material of the liquid crystal layer is twisted nematic liquid crystal (TN-LC).

9. The display apparatus as recited in claim 1, further comprising a control unit electrically connected with the modulatable parallax barrier module and the display panel, wherein the control unit controls the modulatable parallax barrier module to be partially or entirely switched to either the alignment state or the transparent state.

10. The display apparatus as recited in claim 1, wherein a part of the modulatable parallax barrier module is switched to the alignment state, and the other part of the modulatable parallax barrier module is switched to the transparent state.

11. The display apparatus as recited in claim 9, wherein a block of the backlight module corresponding to the modulatable parallax barrier module in the alignment state has a first brightness, and a block of the backlight module corresponding to the modulatable parallax barrier module in the transparent state has a second brightness, wherein the first brightness is different from the second brightness.

12. The display apparatus as recited in claim 11, the control unit controls the boundaries of blocks of the backlight module respectively corresponding to the alignment state and those corresponding to the transparent state to be presented in different brightness.

13. The display apparatus as recited in claim 1, wherein the modulatable parallax barrier module further comprises a liquid crystal layer and a plurality of stripe electrodes, wherein the liquid crystal layer is disposed between the first alignment film and the second alignment film, and the plurality of strip electrodes are disposed on the second alignment film, wherein a part of the modulatable parallax barrier module where the plurality of stripe electrodes are disposed is in the transparent state, and the other part of the modulatable parallax barrier module where the plurality of stripe electrodes are not disposed is presented in the alignment state.

14. A display apparatus, comprising:
a display panel, adapted to providing a linear polarized light having an image information, wherein the linear polarized light has a first polarization direction;
a modulatable parallax barrier module, disposed on the display panel and having an alignment state and a transparent state, wherein the modulatable parallax barrier module has a first alignment film at a light-emitting side and a second alignment film at a light-incident side, the first alignment film has a first alignment direction, and wherein the linear polarized light passing through the modulatable parallax barrier module in the transparent state is kept in the first polarization direction, and the linear polarized light passing through the modulatable parallax barrier module in the alignment state is transformed to a second polarization direction parallel to the first alignment direction; and
a polarizer film, disposed on the first alignment film and having a transmission axis, wherein either the first alignment direction of the first alignment film or a second alignment direction of the second alignment film is inclined toward the transmission axis, and the modulatable parallax barrier module is selectively switched to either the alignment state or the transparent state according to the image information.

15. The display apparatus as recited in claim 14, wherein the modulatable parallax barrier module further comprises:
a liquid crystal layer, disposed between the first alignment film and the second alignment film; and
a plurality of stripe electrodes, disposed on either one of the first alignment film and the second alignment film, wherein a part of the modulatable parallax barrier module where the plurality of stripe electrodes are disposed is presented in the transparent state, and the other part of the modulatable parallax barrier module where the plurality of stripe electrodes are not disposed is presented in the alignment state.

16. The display apparatus as recited in claim 15, further comprising a backlight module, wherein a block of the backlight module corresponding to the modulatable parallax barrier module in the alignment state has a first brightness, and a block of the backlight module corresponding to the modulatable parallax barrier module in the transparent state has a second brightness, wherein the first brightness is different from the second brightness.

17. The display apparatus as recited in claim 16, further comprising a control unit electrically connected with the modulatable parallax barrier module, the display panel and the backlight module, wherein the control unit controls the modulatable parallax barrier module to be partially or entirely switched to either the alignment state or the transparent state according to the image information in the linear polarized light, and controls blocks of the backlight module respectively corresponding to the alignment state and the transparent state to be presented in different brightness.

18. A control method of the display apparatus as recited in claim 1, comprising:
determining whether the image information is a text, a planar image or a 3D image;
entirely switching the modulatable parallax barrier module to the alignment state when the image information is a text or a planar image;
entirely switching the modulatable parallax barrier module to the transparent state when the image information is a 3D image; and
switching a part of the modulatable parallax barrier module to the alignment state and the other part thereof to the transparent state when the image information has both a planar image and a three-dimensional image.

19. The control method of the display apparatus as recited in claim 18, wherein the display apparatus further comprises a control unit electrically connected with the modulatable parallax barrier module and the display panel, the control method further comprising:
the control unit controlling the modulatable parallax barrier module to be entirely switched to the alignment state and controlling the backlight module to execute a brightness modulation when the image information is a text or a planar image;
the control unit controlling the modulatable parallax barrier module to be entirely switched to the transparent state and controlling the backlight module to execute the brightness modulation when the image information is a 3D image; and
the control unit controlling the backlight module to execute the brightness modulation when the image information is either entirely a planar image or entirely a 3D image;
the control unit controlling a part of the modulatable parallax barrier module to be switched to the alignment state and the other part thereof to the transparent state and controlling the backlight module to execute a brightness balance between a block corresponding to the alignment state and a block corresponding to the transparent state when the image information has both a planar image and a 3D image.

20. A control method of the display apparatus as recited in claim 14, comprising:
determining whether the image information is a text, a planar image or a three-dimensional image;
entirely switching the modulatable parallax barrier module to the alignment state when the image information is a text or a planar image; and
switching the part of the modulatable parallax barrier module where a plurality of stripe electrodes are disposed to the transparent state when the image information is a 3D image.

21. A control method of the display apparatus as recited in claim 15, wherein the display apparatus further comprises a control unit electrically connected with the modulatable parallax barrier module, the display panel and a backlight module, the control method further comprising:
the control unit controlling the modulatable parallax barrier module to be entirely switched to the alignment state and controlling the backlight module to execute a brightness modulation when the image information is a text or a planar image;
the control unit controlling the plurality of stripe electrodes of the modulatable parallax barrier module so that the region of the modulatable parallax barrier module where the plurality of stripe electrodes are disposed is switched to the transparent state; and
the control unit partially modulating the brightness of the backlight module.
